(19) United States
(12) Patent Application Publication
(10) Pub. No.: US 2021/0292929 A1
(43) Pub. Date: Sep. 23, 2021

(54) METHODS AND SYSTEMS FOR REDOX-TRIGGERED SURFACE IMMOBILIZATION OF POLYIONIC SPECIES ON A SUBSTRATE

(71) Applicant: Auburn University, Auburn, AL (US)

(72) Inventors: Wei ZHAN, Auburn, AL (US); MD. Shamim IQBAL, Auburn, AL (US)

(21) Appl. No.: 16/997,268

(22) Filed: Aug. 19, 2020

Related U.S. Application Data
(60) Provisional application No. 62/957,649, filed on Jan. 6, 2020.
(60) Provisional application No. 62/888,758, filed on Aug. 19, 2019.

(51) Int. Cl. C25D 13/04; C25D 13/12; C25D 13/20

(52) U.S. Cl. CPC C25D 13/04; G01N 27/3277; C25D 13/20; C25D 13/12

(57) ABSTRACT

Described herein are methods for the surface deposition of polyionic species on a substrate surface. This deposition process can be triggered facilely by oxidizing organometallic species present on the surface of the substrate. This approach is quite general, affording quantitative deposition of polyionic species with a wide range of chemical identities (e.g., synthetic polymers, peptides and DNA) and molecular weights. This approach is in addition suitable for surface deposition of several types of functional materials, including proteins (antibodies), nanomaterials, colloids, lipid vesicles, among others.

### CROSS REFERENCE TO RELATED APPLICATIONS

This application claims the benefit of U.S. Provisional Application No. 62/888,758, filed on Aug. 19, 2019 and U.S. Provisional Application No. 62/957,649, filed on Jan. 6, 2020, both of which are incorporated herein by reference in their entireties.

### STATEMENT REGARDING FEDERALLY SPONSORED RESEARCH OR DEVELOPMENT

This invention was made with Government support under Contract/Grant No. CHE-1808123 awarded by the National Science Foundation. The Government has certain rights in the invention.

### BACKGROUND

The ability to deposit macromolecules on a surface has broad potential and applications. For example, if a known quantity of an antibody can be deposited on a surface, the resulting surface can be used as an effective biosensor for viruses. The current challenge is the ability to quantitatively deposit macromolecules so that the precise amount of the macromolecule deposited on the substrate surface is known. There remains a need for methods for quantitatively depositing macromolecules on a substrate surface. The present disclosure addresses this need.

### SUMMARY

Described herein are methods for the surface deposition of polyionic species on a substrate surface. This deposition process can be triggered facilely by oxidizing organometallic species present on the surface of the substrate. This approach is quite general, affording quantitative deposition of polyionic species with a wide range of chemical identities (e.g., synthetic polymers, peptides and DNA) and molecular weights. This approach is in addition suitable for surface deposition of several types of functional materials, including proteins (antibodies), nanomaterials, colloids, lipid vesicles, among others.

Other systems, methods, features, and advantages of sensor fabrication and solid-state device preparations will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Further aspects of the present disclosure will be readily appreciated upon review of the detailed description of its various embodiments, described below, when taken in conjunction with the accompanying drawings.

FIGS. 1A-1D shows voltammetric monitoring of Fc SAMs undergoing either linear or cyclic potential sweeps in 1.0 mM poly(acrylic acid sodium salt) (PAA, M.W. 8000 Da) aqueous solutions. (a) Voltammetric monitoring of 1:1 Fc-C11SH/C12SH mixed SAMs treated by a cyclic potential sweep in 1.0 mM PAA. CVs shown in black were acquired in 0.1 M NaClO₄ aqueous solutions before (solid line) and after (dashed line) the CV scan in PAA. A control CV (in gray) obtained in 0.1 M NaCl is also included. (b) Voltammetric monitoring of 1:1 Fc-C11SH/C12SH mixed SAMs undergoing 10 consecutive cyclic potential scans in 1.0 mM PAA; the red arrows point to the direction of current decrease. (c) Voltammetric monitoring of 1:1 Fc-C11SH/C12SH mixed SAMs undergoing a linear potential sweep in 1.0 mM PAA. (d) Voltammetric monitoring of pure Fc-C11SH SAMs undergoing a linear potential sweep in 1.0 mM PAA. Potential scan rate: 100 mV/s.

FIGS. 2A-2B show voltammetric monitoring of 1:1 Fc-C11SH/C12SH mixed SAMs undergoing linear (a) and cyclic (b) potential sweeps in 1.0 mM poly(L-lysine hydrochloride) (PL, M.W. 8200 Da) aqueous solutions. All CVs shown in black were acquired in 0.1 M NaClO₄ aqueous solutions, whereas voltammograms shown in green and red were recorded in 1.0 mM PL dissolved in water. A control CV (in gray) obtained in 0.1 M NaCl is also included in (b). Potential scan rate: 100 mV/s.

FIGS. 3A-3B show fluorescence spectroscopic characterization of electrochemically triggered polyelectrolyte deposition processes. (a) Representative fluorescence emission spectra collected on 1:1 Fc-C11SH/C12SH mixed SAMs or pure C12SH SAMs undergoing various treatments. All treatments were carried out in 1.0 mM poly(fluorescein isothiocyanate allylamine hydrochloride) (M.W. ˜16,200 Da) aqueous solutions. (b) Representative fluorescence emission spectra collected on 1:1 Fc-C11SH/C12SH mixed SAMs undergoing either CV deposition (green) or 30-min incubation (black) in 50.0 μM 5′-fluorescein-labeled adenine 25-mer (M.W. ˜8,300 Da). The embedded cartoons depict the charge and skeleton of the fluorescent polyelectrolytes employed.

FIG. 4 shows the electrochemical QCM monitoring of polyelectrolyte deposition on 1:1 Fc-C11SH/C12SH mixed SAMs. Responses of crystal oscillation frequency shift vs. time obtained from 1.0 mM PAA (anionic) and PL (cationic) in water are shown in green and red, respectively. In each case, the solution-facing gold electrode on the crystal is biased between 0.1 and 0.8 V vs. Ag/AgCl with a scan rate of 100 mV/s (waveform shown in solid black). A control response (in blue) recorded in water only is also included. The first complete CV scan is highlighted by light yellow/blue stripes.

FIGS. 5A-5D show AFM characterization of polyelectrolyte deposition on Fc SAMs triggered by a linear potential sweep from 0.1 to 0.8 V vs. Ag/AgCl. (a) 1.0 mM PAA (M.W. 15000 Da) on a 1:1 Fc-C11SH/C12SH mixed SAM. (b) DNA from calf thymus (M.W. ˜10-15×10⁶ Da) on a 1:1 Fc-C11SH/C12SH mixed SAM. (c) DNA from calf thymus on a pure Fc-C11SH SAM. (d) Height vs. distance profiles of selected sections in images a-c. Scan size: 2×2 μm. See the Experimental Section for details.

FIG. 6 shows a schematic illustration of mechanisms involved in the electrochemically triggered deposition of polyelectrolytes. Polyanions and polycations are depicted by thick curves in blue and yellow, respectively, whereas their counterions are presented by small dots (gray for cations and green for anions). Intrinsic charges on polyelectrolytes are shown by circles.

FIGS. 7A-7B show layer-by-layer polyelectrolyte deposition starting from a PAA layer deposited by the reported method. (a) Ten-layer film growth monitored by UV-vis absorption responses of poly(fluorescein isothiocyanate allylamine hydrochloride), which is deposited at even-numbered rounds. (b) Net UV-vis absorbance of poly(fluorescein isothiocyanate allylamine hydrochloride) monitored at ˜505 nm vs. number of layers, replotted from a).

FIG. 8A shows a schematic of the three-electrode experimental setup. For clarity, the Ag/AgCl reference electrode and assembly sockets are not included in the drawing. FIG. 8B shows background electrochemical processes probed in DI water using either bare or 1:1 Fc-C11SH/C12SH mixed SAM-covered gold films as working electrode.

FIGS. 9A-9B show linear sweep voltammograms (LSV) recorded on either bare gold films (a) or gold films covered with 1:1 Fc-C11SH/C12SH mixed SAMs (b) in aqueous suspensions of 0.5-μm PS-COOH beads (concentration: ˜1×10⁹ per mL). The suspensions in addition contain 0.05% (w/v) TWEEN 20; scan rate: 10 mV/s. The embedded fluorescence images in each case are obtained from three separate potential scans covering 0.1-0.4 V, 0.1-0.7 V, and 0.1-1 V, respectively. Only the LSVs of 0.1-1 V are shown here; the two short scans overlap with the corresponding segments of the former, and are omitted for clarity. The scale bar represents 50 μm and applies to all images.

FIG. 10 shows the electrochemical QCM monitoring of deposition of 0.5-μm PS-COOH beads (low-density: ˜1×10⁷ per mL vs. high density: ˜1×10⁹ per mL) on either bare gold electrodes or gold electrodes covered with 1:1 Fc-C11SH/C12SH mixed SAMs. The samples in addition contain 0.05% (w/v) TWEEN 20. In each case, the gold electrodes were biased by a liner potential scan from 0.1 to 0.9 V at 10 mV/s, as marked by the yellow triangle.

FIGS. 11A-11D show a) linear sweep voltammogram of patterned 1:1 Fc-C11SH/C12SH mixed SAMs probed in 0.5-μm PS-COOH microbead aqueous suspensions (concentration: ˜1×10⁹ per mL, with 0.05% (w/v) TWEEN 20). Inset: schematic depiction of the layout and dimensions of the microarray employed in microcontact printing of thiols. b) to d) Fluorescence images of gold film electrodes covered with 1:1 Fc-C11SH/C12SH mixed SAM micropatterns after a single LSV scan from 0.1 to 0.4 V (b), 0.1 to 0.7 V (c), and 0.1 to 1 V (d), in 0.5-μm microbead aqueous suspensions. Potential scan rate: 10 mV/s; scale bar: 50 μm.

FIG. 12 shows the linear sweep voltammograms of 1:1 Fc-C11SH/C12SH mixed SAMs probed in 0.5-μm PS-COOH microbead aqueous suspensions (bead concentration: ˜1×10⁹ per mL, 0.05% (w/v) TWEEN 20) in the presence of either 0.1 M NaClO₄ (green) or 0.1 M NaCl (black and white). Inset: fluorescence images of the SAM-covered gold surfaces following the LSV treatments. Potential scan rate: 10 mV/s; scale bar: 50 μm.

FIGS. 13A-13F show fluorescence images of electrochemically triggered deposition of PS-COOH beads of various sizes on 1:1 Fc-C11SH/C12SH mixed SAMs. Bead size (from a to f): 0.06 μm, 0.22 μm, 0.51 μm, 1.0 μm, 2.19 μm and 4.95 μm; their concentrations are specified in Table 3. All samples were treated by a single LSV scan from 0.1 to 0.8 V at 10 mV/s. The scale bars correspond to 50 μm.

FIG. 14 shows a schematic illustration of some key mechanistic features of the electrochemically triggered deposition. Following FIG. 8A (with 90° rotation), the primary electric field is established between Au film W.E. and Pt wire C.E. Upon Fc-SAM oxidation, a secondary field also develops between the Fc⁺ layer (orange circles with embedded plus signs) and the front of the counterion influx (green circles with embedded minus signs). Colloidal particles (one shown in gold) situated within this zone are subjected to the influence of both fields, whose interactions generate secondary electrokinetic flows. The drop shadow in purple depicts the distorted diffuse layer of the bead particularly caused by the local secondary electric field; arrowed lines in gray are idealized streamlines of the flow pattern.

FIG. 15 shows a head portrait of Einstein formed by 0.06-μm green-fluorescent PS-COOH beads assembled on a gold film electrode using our electrochemically-triggered approach. Prior to the assembly step, the portrait pattern was first microcontact-printed onto the gold electrode in form of 1:1 Fc-C11SH/C12SH mixed SAMs via a silicone rubber stamp. A liner potential sweep from 0.1 to 0.8 V was then applied at 10 mV/s; scale bar: 50 μm.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. There are many variants and adaptations of the embodiments described herein. These variants and adaptations are intended to be included in the teachings of this disclosure.

All publications and patents cited in this specification are cited to disclose and describe the methods and/or materials in connection with which the publications are cited. All such publications and patents are herein incorporated by reference as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of nanotechnology, organic chemistry, material science and engineering and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y.’ The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z.’ Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z.’ In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y.’”

In some instances, units may be used herein that are non-metric or non-SI units. Such units may be, for instance, in U.S. Customary Measures, e.g., as set forth by the National Institute of Standards and Technology, Department of Commerce, United States of America in publications such as NIST HB 44, NIST HB 133, NIST SP 811, NIST SP 1038, NBS Miscellaneous Publication 214, and the like. The units in U.S. Customary Measures are understood to include equivalent dimensions in metric and other units (e.g., a dimension disclosed as “1 inch” is intended to mean an equivalent dimension of “2.5 cm”; a unit disclosed as “1 pcf” is intended to mean an equivalent dimension of 0.157 kN/m³; or a unit disclosed 100° F. is intended to mean an equivalent dimension of 37.8° C.; and the like) as understood by a person of ordinary skill in the art.

### Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

“Alkylene group” as used herein is a branched or unbranched saturated hydrocarbon group of 1 to 24 carbon atoms, such as methylene, ethylene, n-propylene, isopropylene, n-butylene, isobutylene, t-butylene, pentylene, hexylene, heptylene, and the like. The alkylene group can also be substituted or unsubstituted. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below. In certain aspects, one or more methylene units (CH₂) in the alkylene group can be substituted with a heteroatom such as, for example, oxygen, sulfur, or nitrogen.

### Substrates for Immobilizing Polyionic Species

Described herein are substrates that have been modified to immobilize polyionic species. In one aspect, the substrate comprises a plurality of organometallic species on a surface of the substrate, wherein the metal comprises iron, ruthenium, osmium, cobalt, or any combination thereof.

The selection and amount of the metal ions that are present on the surface of the substrate can vary depending upon, amongst other variables, the polyionic species that is to be immobilized. In one aspect, the metal ions are organometallic species. “Organometallic ions” as used herein are metal ions (iron, ruthenium, osmium, or cobalt) that are coordinated by one or more organic ligands. The selection of the ligand can vary depending upon the metal ion that is used. The ligand can form a variety of different types of bonds with the metal ion including, but not limited to, covalent bonding, hydrogen bonding, Van der Waals bonding, and the like. In one aspect, the ligand can be a trans-spanning ligand (i.e., a bidentate ligand that can span coordination positions on opposite sides of a coordination complex), an ambidentate ligand (i.e., a ligand that can attach to the central atom in two places), a bridging ligand (i.e., a ligand links two or more metal centers). In one aspect, the ligand is a corrole, a crown ether, a cryptate, cyclopentadiene, diethylenetriamine (dien), dimethylglyoximate (dmgH⁻), 1,4,7,10-tetraazacyclododecane-1,4,7,10-tetraacetic acid (DOTA), diethylenetriaminepentaacetic acid (DTPA) (pentetic acid), ethylenediaminetetraacetic acid (EDTA) (edta⁴⁻), ethylenediaminetriacetate, or ethyleneglycolbis(oxyethylenenitrilo)tetraacetate (egta⁴⁻).

In one aspect, the plurality of organometallic species is covalently bonded to the surface of the substrate by an organic linker. In one aspect, the organic linker comprises a substituted or unsubstituted alkylene group. In another aspect, the organic linker is a C₁-C₂₀ alkylene group.

Depending upon the selection of the substrate, the organic linker can be modified with a functional group that can form a covalent bond with the substrate. For example, when the substrate is composed of gold, the organic linker can possess one or more thiol groups. In this aspect, the thiol group forms a covalent bond with gold. In other aspects, the organic linker can be modified with a functional group that can form a covalent bond with glass. For example, the organic linker can be modified with hydroxyl or silane groups that can form covalent bonds with silicon glass.

In certain aspects, the organic linker can include one or more ligands that can bind with the metal ion. In one aspect, the ligand can be any of the compounds as provided above. In one aspect, the organic linker has the formula X—Y—Z, where X is a functional group that can form a covalent bond with the substrate (e.g., hydroxyl, thiol), Y is a C₁-C₂₀ alkylene group, and Z is a ligand. In one aspect, Z is cyclopentadiene.

In another aspect, the organometallic ions are not covalently bonded to the surface of the substrate. In one aspect, a polymer comprising backbone can have a plurality of organometallic ions attached (i.e., pendant) to the polymer backbone. In this aspect, the polymer with the pendant organometallic ions can be adsorbed to the surface of the substrate. In one aspect, the polymer that provides the basis of the polymer backbone selected is inert, where the polymer does not interact with the polyionic species to be immobilized. In one aspect, the polymer is hydrophobic. In one aspect, the pendant organometallic ions can be grafted to the polymer backbone. In another aspect, the polymer can be modified with an organic linker as described herein followed by the addition of the metal ions.

In another aspect, noncovalent attachment of the organometallic ions can be accomplished with the use of surfactants such as fatty acids that contain phosphonates or sulfonates. Here, the surface of the substrate is coated with the surfactant, where the surfactant can non-covalently bond with the organometallic ions.

The material in the substrate can vary depending upon the application of the methods described herein. In one aspect, the material of the substrate is inert, where the substrate does not interact with the polyionic species to be immobilized. In one aspect, the substrate can be composed of a material used to produce an electrode. In one aspect, the materials is a metal, semiconductor, oxide semiconductor, or carbon. Examples of such materials include, but are not limited to, gold, glass, aluminum, copper and carbon. In one aspect, the substrate comprises a semiconductor material comprising TiO₂, V₂O₅, ZnO, SnO₂, Fe₂O₃, In₂O₃, ZrO₂, WO₃, MoO₃, SiC, ZS, CdS, MoS₂, an ilmenite, FeTiO₃, FeCrO₄, a perovskite, or a pseudobrookite.

The substrate material may be doped with metal ions (e.g., Si, Al, Mg, V, Cr, Mn, Fe, Nb, Mo, W or Ru) introduced into their lattice to beneficially modify their properties, such as absorption or conductivity, for use in this invention. Semiconductors may have metal (transition metals, e.g., Cu or Ni, or other metals, e.g., Rh, Pd, Ag, Pt, Hg) deposited on their surfaces to beneficially modify their properties, such as absorption or conductivity.

The substrates described herein may be used in different physical forms such as, for example, particles, finely divided particles, or embedded, coated, layer or incorporated into other materials The substrate material may be provided as a layer on a non-conductive solid such as glass, quartz, plastic or a solid polymer.

### Methods for Immobilizing Polyionic Species

The methods described herein are effective in quantitatively immobilizing polyionic species on a substrate surface. “Polyionic species” as used herein is a compound possessing two or more ionizable groups. The number of ionizable groups can vary depending upon the selection and size (i.e., molecular weight) of the polyionic species. An “ionizable group” as used herein is any neutral group that can be converted to a charged group. For example, a carboxylic acid (—COOH) can be converted to a carboxylate (—COO⁻) by treating the acid with a base. In one aspect, the polyionic species can be a polyanionic compound having two or more carboxylate groups, sulfate groups, sulfonate groups, borate groups, boronate groups, phosphonate groups, or phosphate groups. In another aspect, the polyionic species can be a polycationic compound having two or more amine groups.

Depending upon the selection of the polyionic species and the conditions of the solution composed of the polyionic species (e.g., pH), the polyionic species can include ionizable groups in the neutral and charged state. For example, the polyionic species can include both carboxylic acid and carboxylate groups. The polyionic species useful herein can 100% of the neutral species (e.g., 100% carboxylic acid groups), 100% of the ionized groups (e.g., 100% carboxylate groups), or any variation thereof (e.g., 50/50 carboxylic acid/carboxylate groups, 25/75 carboxylic acid/carboxylate groups, etc.).

In certain aspects, the polyionic species can be zwitterionic. In this aspect, the number of anionic and cationic ionizable groups present in the polyionic species can vary depending upon the nature and selection of the polyionic species.

In certain aspects, the polyionic species can be two or more compounds. In one aspect, the polyionic species can include two or more polyanionic compounds. In another aspect, the polyionic species can include two or more polycationic compounds. In another aspect, the polyionic species can include a mixture of one or more polyanionic and polycationic compounds.

In one aspect, the polyionic species is a quantum dot, a liposome, a metal nanoparticle, a magnetic nanoparticle, a carbon nanotube, an antibody, a colloid, an oligonucleotide, a polypeptide, or a protein.

The methods described herein involve oxidizing a plurality of precursor organometallic species present on the surface of the substrate to produce a plurality of metal ions on the surface of the substrate. An example of this depicted below for ferrocene (Fc):

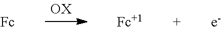

where ferrocene (the precursor metal species) is oxidized to⁻ ferrocenium (the deposition trigger). In one aspect, the precursor metal species is first attached (covalently or non-covalently) to the surface of the substrate followed by oxidation of the precursor metal species. The precursor organometallic species can be a zero-valent metal or metal ion capable of being oxidized.

In one aspect, the plurality of precursor organometallic species is oxidized by chemical oxidation. The selection and amount oxidizing agent can vary depending upon the nature and amount of precursor organometallic species present on the surface of the substrate. In one aspect, the substrate with the plurality of organometallic precursor species is contacted with a solution comprising the oxidizing agent. In one aspect, the solution is an aqueous-based solution, where the majority if not all of the solution is composed of water. In another aspect, the oxidizing agent is a small oxidant such as oxygen dissolved in water or in a solution.

In another aspect, the plurality of precursor organometallic species is oxidized by applying a potential to the substrate to heterogeneously produce a plurality of oxidized form of the precursor species. The amount and duration of the potential applied can vary depending upon the nature and amount of precursor organometallic species present on the surface of the substrate. In one aspect, the potential is provided from about +/−0.1 V to about +/−1 V, or about +/−0.1 V, about +/−0.2 V, about +/−0.3 V, about +/−0.4 V, about +/−0.5 V, about +/−0.6 V, about +/−0.7 V, about +/−0.8 V, about +/−0.9 V, about +/−1.0 V, where any value can be a lower and upper endpoint of a range (e.g., about +/−0.3 V to about +/−0.7 V, etc.). The source of the potential to be applied can be a battery or other power-generating devices known in the art. In another aspect, the potential is applied by one or more electrodes.

The order in which oxidation can occur relative to the immobilization of the polyionic species can vary. In one aspect, the substrate is contacted with the solution comprising the polyionic species followed by oxidizing the plurality of organometallic precursor species on the substrate. In another aspect, the substrate with the plurality of organometallic precursor species is oxidized followed by contacting the substrate with the solution comprising the polyionic species. In another aspect, the substrate with the plurality of organometallic precursor species is simultaneously oxidized and contacted with the solution comprising the polyionic species.

In one aspect, the substrate is contacted with the solution comprising the polyionic species followed by applying a potential to the plurality of organometallic precursor species on the substrate. In another aspect, the substrate with the plurality of organometallic precursor species is oxidized by applying a potential followed by contacting the substrate with the solution comprising the polyionic species. In another aspect, the substrate with the plurality of organometallic precursor species is simultaneously oxidized by applying a potential and contacted with the solution comprising the polyionic species.

The solution comprising the polyionic species include one or more solvents. In one aspect, the solvent includes water. In another aspect, the solvent is water having from about 50 wt % to 100 wt %, or about 50 wt %, about 60 wt %, about 70 wt %, about 80 wt %, about 90 wt %, or 100 wt % of the solution, where any value can be a lower and upper endpoint of a range (e.g., about 70 wt % to about 90 wt %, etc.).

The methods described herein are effective in immobilizing polyionic species from a solution to the substrate surface. Depending upon the selection of the metal ions present on the substrate surface and the polyionic species to be immobilized (i.e., polyionic species removed from solution), the degree of immobilization between the organometallic species and the polyionic species can vary. In one aspect, varying the amount of oxidation of the organometallic precursor species on the substrate can determine the amount of polyionic species that can be immobilized on the substrate surface. For example, a potential in a specified amount and duration can be applied in order to immobilize a specific amount of polyionic species from solution. In addition to modifying oxidation parameters, additional parameters can be modified to such that quantifiable amounts of the polyionic species can be immobilized from solution. Examples of such parameters include, but are not limited to, the surface density of the organometallic precursor species present on the substrate surface, the concentration and ionic strength of the polyionic species, and the pH of the solution composed of the polyionic species.

### Applications

The methods described herein permit the quantitative immobilization (i.e., deposition) of polyionic species on a substrate. With this said, the substrates described herein with immobilized polyionic species have numerous applications in the field of sensors. In one aspect, the immobilized polyionic species can be a sensing element in a sensor. For example, when the polyionic species is a nucleic acid, antibody or a protein, the substrate with immobilized polyionic species can be used in the health industry for screening and diagnostics. In another aspect, the polyionic species can be colloidal particles with biomarkers having an affinity to specific types of biomolecules can be bonded to the colloidal particles prior to immobilization of the colloidal particles to the substrate.

When the interaction between the immobilized polyionic species and analyte of interest varies, detectable changes in electrical properties of the substrate are induced. In one aspect, induced changes in electrical properties include, but are not limited to impedance, conductivity, surface plasmon resonance, electrochemical, fluorescence energy transfer, or anodic stripping (when metal nanoparticles are used in the mix). Measuring changes in one or more electrical properties of the substrate can be used to determine the concentration of analyte in the sample. Moreover, by knowing the amount of immobilized polyionic species present on the substrate as [provided by the methods described herein, more precise quantification of an analyte of interest is possible. The substrates described herein can be incorporated in or configured with any sensor including, but not limited to, microfluidic devices and other assaying equipment/instrumentation.

### Aspects

The present disclosure can be described in accordance with the following numbered Aspects, which should not be confused with the claims.

Aspect 1. A method for immobilizing a polyionic species from a solution, the method comprising contacting the solution with a substrate comprising a plurality of metal ions on a surface of the substrate, wherein the metal comprises iron, ruthenium, osmium, cobalt, or any combination thereof.

Aspect 2. The aspect of claim 1, wherein the metal ions comprises organometallic species

Aspect 3. The method of aspect 1 or 2, wherein the plurality of metal ions is covalently bonded to the surface of the substrate by an organic linker.

Aspect 4. The method of aspect 3, wherein the organic linker comprises a substituted or unsubstituted alkylene group.

Aspect 5. The method of aspect 3, wherein the organic linker comprises a ligand that binds with the metal ion.

Aspect 6. The method of aspect 5, wherein the ligand comprises a corrole, a crown ether, a cryptate, cyclopentadiene, diethylenetriamine (dien), dimethylglyoximate (dmgH⁻), 1,4,7,10-tetraazacyclododecane-1,4,7,10-tetraacetic acid (DOTA), diethylenetriaminepentaacetic acid (DTPA) (pentetic acid), ethylenediaminetetraacetic acid (EDTA) (edta⁴⁻), ethylenediaminetriacetate, or ethyleneglycolbis(oxyethylenenitrilo)tetraacetate (egta⁴⁻).

Aspect 7. The method of any one of aspects 1-6, wherein the organometallic species are pendant groups on a polymer backbone.

Aspect 8. The method of any one of aspects 1-7, wherein the substrate comprises gold, glass, aluminum, copper and carbon.

Aspect 9. The method of any one of aspects 1-7, wherein the substrate comprises a semiconductor material comprising TiO₂, V₂O₅, ZnO, SnO₂, Fe₂O₃, In₂O₃, ZrO₂, WO₃, MoO₃, SiC, ZS, CdS, MoS₂, an ilmenite, FeTiO₃, FeCrO₄, a perovskite, or a pseudobrookite.

Aspect 10. The method of any one of aspects 1-9, wherein a plurality of precursor metal ions is oxidized to produce the plurality of metal ions on the surface of the substrate.

Aspect 11. The method of aspect 10, wherein the plurality of precursor organometallic species is oxidized by chemical oxidation.

Aspect 12. The method of aspect 10, wherein the plurality of precursor organometallic species is oxidized by applying a potential to the substrate comprising the plurality of precursor organometallic species.

Aspect 13. The method of aspect 12, wherein the potential bias is provided from about +1-0.1 V to about 1 V.

Aspect 14. The method of aspect 12, wherein the potential is applied by one or more electrodes.

Aspect 15. The method of any one of aspects 1-14, wherein (1) the substrate is contacted with the solution comprising the polyionic species followed by (2) applying a potential to the substrate.

Aspect 16. The method of any one of aspects 1-14, wherein (1) a potential is applied to the substrate followed by (2) contacting the substrate with the solution comprising the polyionic species.

Aspect 17. The method of any one of aspects 1-16, wherein the substrate comprises a plurality of ferrocene groups, wherein the plurality of ferrocene groups is oxidized by applying a potential to the substrate to produce a plurality of ferrocenium ions on the surface of the substrate.

Aspect 18. The method of any one of aspects 1-17, wherein the polyionic species comprises a neutral compound, a salt thereof, or a combination thereof.

Aspect 19. The method of any one of aspects 1-17, wherein the polyionic species comprises a polyanion, wherein the polyanion comprises a polymer comprising two or more carboxylate groups, sulfate groups, sulfonate groups, borate groups, boronate groups, phosphonate groups, or phosphate groups.

Aspect 20. The method of any one of aspects 1-17, wherein the polyionic species comprises a polycation, wherein the polycation comprises a polymer comprising two or more amine groups.

Aspect 21. The method of any one of aspects 1-17, wherein the polyionic species comprises a quantum dot, a liposome, a metal nanoparticle, a magnetic nanoparticle, a carbon nanotube, an antibody, a colloid, an oligonucleotide, a polypeptide, or a protein.

Aspect 22. The method of any one of aspects 121, wherein the solution comprises water.

Aspect 23. A substrate comprising an immobilized a polyionic species produced by the method of any one of aspects 1-22.

Aspect 24. A sensor comprising the substrate of aspect 22.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

### Electrochemically Triggered Surface Deposition of Polyelectrolytes

Experimental Section

Reagents. 11-Ferrocenyl-1-undecanethiol (Fc-C11SH), 1-dodecanethiol (C12SH), poly(acrylic acid sodium salt), poly(allylamine hydrochloride), poly(fluorescein isothiocyanate allylamine hydrochloride) with a polymer to fluorophore mole ratio of 50:1, deoxyribonucleic acid sodium salt from calf thymus, sodium perchlorate hydrate (99.99% trace metal basis) were products of Sigma-Aldrich (St. Louis, Mo.). Poly(L-lysine hydrochloride) and poly(L-glutamic acid sodium salt) were obtained from Alamanda Polymers (Huntsville, Ala.). 5′-fluorescein-labeled poly(adenine) 25-mer was obtained from Integrated DNA Technologies, Inc. (Coralville, Iowa). The structure and molecular weights of these polymers are listed in Table 1. Deionized water of 18.2 MΩ·cm (Millipore) was used in preparing all aqueous solutions as well as in all rinsing steps.

TABLE 1
Polyelectrolytes Investigated in This Study and Their Structure
and Molecular Weight

| Polymer | Structure |
|---|---|
| Poly(acrylic acid sodium salt) 2100 8000 15000 | 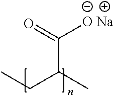 |
| Poly(L- glutamic acid sodium salt) 7500 | 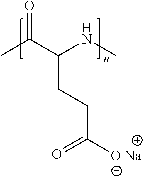 |
| Poly(L-lysine HCl) 3300 8200 16000 | 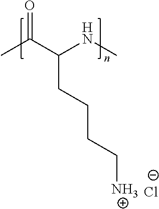 |
| DNA sodium | not shown |
| salt from | |
| calf thymus | |
| 10-15 × 10⁶ | |
| Poly(fluorescein isothiocyanate allyamine HCl) 16200 17500^{a} 5′-fluorescein- labeled poly(adenine) 25-mer 5′-fluorescein- (A)₂₅-3′ 8300 | 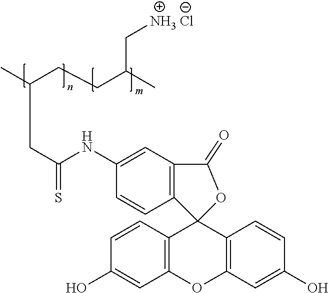 |

^{a}Poly(allylamine HCl) only.

Formation of Self-Assembled Monolayers. Self-assembled monolayers (SAMs) of Fc-C11SH, either pure or mixed 1:1 (mole ratio) with C12SH, were formed on three types of gold-coated substrates depending on the intended use. For voltammetric and water contact angle characterization, the substrates were prepared in-house by sputtering gold onto chromium-coated silicon wafers (Au thickness: ˜1000 nm). The other two substrates were commercially obtained: semi-transparent gold-coated microscope slides (Au thickness: 10 nm, Sigma-Aldrich) for fluorescence spectroscopy and atomic force microscopy, and gold-coated quartz crystal wafers with a Cr adhesion layer (diameter: 1 inch, Stanford Research System, Sunnyvale, Calif.) for quartz crystal microbalance. Right before their incubation in thiol solutions, these substrates were immersed in a piranha solution (3:1 v/v mixture of concentrated H₂SO₄ and H₂O₂ 30 wt % aqueous solution) for either 15 (for the gold-coated Si wafers) or 3 min (for the other two substrates), thoroughly rinsed with deionized water, ethanol, and then dried under N₂. Thus cleaned dry substrates were immediately immersed in an ethanol solution dissolved either with 0.5 mM Fc-C11SH and C12SH each (for mixed Fc SAMs), or with 1.0 mM Fc-C11SH alone (for pure Fc SAMs). The incubation was allowed to proceed for 16-18 h in the dark, after which the substrates were thoroughly rinsed with methanol to remove excess thiols on surface, then deionized water, and finally dried under N₂. These freshly prepared SAMs are immediately subjected to their next treatments as specified below.

Electrochemical Treatments and Characterization. Cyclic voltammetry (CV) and linear sweep voltammetry (LSV) were used in this work to 1) initiate polyelectrolyte deposition on Fc SAMs and 2) to electrochemically characterize the Fc SAMs before/after the deposition step. These measurements were performed in homemade Teflon cells housing SAM-covered gold substrates as the working electrode, a platinum wire as the counter electrode and Ag/AgCl in saturated KCl solution as the reference electrode, and are operated by a PC-controlled potentiostat (CHI 910B, CH Instruments, Austin, Tex.) with a potential scan rate of 100 mV/s. In the order of operation, a given SAM is typically treated with three separate voltammetric scans: 1) a CV scan in 0.1 M NaClO₄, 2) an LSV or a CV scan in a 1.0 mM (polymer concentration) aqueous solution of a polyelectrolyte and 3) another CV scan back in 0.1 M NaClO₄. In between scans, the solution occupying the electrochemical cell was thoroughly exchanged out first with deionized water and then with the medium intended for the next scan. To ensure reproducibility, it is critical to keep the SAM immersed in liquid during the entire time of these voltammetric runs.

Water Contact Angle Measurement. A Rame-Hart model 200 automated goniometer (Succasunna, N.J.) was used to measure the water contact angles of Fc-C11SH/C12SH mixed SAMs at room temperature. The Rame-Hart DROPimage Standard software was used to collect images and analyze the obtained angles. Prior to a measurement, a SAM was first LSV-treated in either DI water alone or a 1.0 mM polyelectrolyte aqueous solution, thoroughly washed with deionized water, and then dried under N₂. In each case, a measurement was promptly taken after a 4 μL deionized water droplet was gently placed onto the SAM.

Electrochemical Quartz Crystal Microbalance (EQCM). EQCM measurements were carried out on a Stanford Research Systems QCM analyzer with a 5 MHz crystal oscillator (Model: QCM25, Sunnyvale, Calif.) at room temperature. The quartz crystal used here are polished quartz wafers of 1 inch diameter with circular gold electrodes coated on both sides, which are first grafted with a 1:1 Fc-C11SH/C12SH mixed SAM as described above. The SAM-coated crystal was subsequently mounted on the QCM crystal holder and its solution-facing electrode was used as the working electrode in a three-electrode configuration together with a Pt-wire counter electrode and a Ag/AgCl reference electrode (in saturated KCl). To do so, a PC-controlled potentiostat (CHI 910B, CH Instruments) was connected to the QCM crystal holder via the crystal face bias connector of the QCM25 crystal controller. This setup enables simultaneous monitoring of the QCM frequency shift and current on the working electrode (crystal) as a function of the applied potential. The potential is fed by the potentiostat in the form of 10 consecutive CV scans between 0.1 to 0.8 V except for the first sweep, which starts at the open-circuit potential of the cell; scan rate: 100 mV/s.

Fluorescence Spectroscopy. Fluorescence emission spectra of fluorescein-conjugated polyelectrolytes deposited on semi-transparent gold-coated microscope slides were acquired on a PI Acton spectrometer (Spectra Pro SP 2356, Acton, N.J.) equipped with a CCD camera (PI Acton PIXIS: 400B, Acton, N.J.). This spectrometer is connected to the side port of an epifluorescence microscope (Nikon TE-2000 U, Japan), which provides light selection (excitation: 470±11 nm; dichroic: 484 nm long pass; emission: 496 nm long pass) and holds the sample cells. For sample preparation, the gold-coated microscope slides were first grafted with 1:1 Fc-C11SH/C12SH mixed SAMs, which were then subjected to an LSV (or a CV) scan either in a 1.0 mM aqueous solution of poly(fluorescein isothiocyanate allylamine hydrochloride), or in a 10 μM aqueous solution of 5′-fluorescein-labeled poly(adenine) 25-mer; potential scan rate: 100 mV/s. Following the electrochemical treatment, the SAMs were thoroughly rinsed with deionized water to remove unbound polyelectrolytes. The resulting films remain immersed in deionized water during the entire course of fluorescence acquisition.

Atomic Force Microscopy (AFM). AFM characterization of polymer-modified SAMs was carried out using a Bruker MultiMode 8 atomic force microscope (Bruker, USA) in air and at room temperature. Silicon nitride probes (Model: ScanAsyst AIR, Bruker) used in these measurements have a force constant of 0.4 N/m, a resonant frequency of 70 kHz, a nominal tip radius of 2 nm and are operated in Scanasyst Air mode with a scan rate of 1 Hz and a resolution of 512×512 pixels. The substrates used are semi-transparent gold-coated microscope slides, on which ferrocene SAMs were first formed as described above. For deposition of polyelectrolytes, these SAMs were then subjected to a linear potential sweep from 0.1 to 0.8 V vs. Ag/AgCl at 100 mV/s in the following aqueous solutions: 1.0 mM poly(acrylic acid sodium salt, M.W. ˜15 kDa) and poly(L-lysine hydrochloride, M.W. ˜16 kDa), and 0.1 μM DNA from calf thymus. Thus treated SAMs were thoroughly rinsed with deionized water and then dried under N₂ before AFM scanning. All AFM images presented in this work are original with no graphical touchup.

Layer-by-Layer Polyelectrolyte Deposition. Pure Fc-C11SH SAMs deposited with poly(acrylic acid sodium salt) were used as the starting surfaces to build layer-by-layer polyelectrolyte films. These Fc-C11SH SAMs were formed on semi-transparent gold-coated microscope slides, on which poly(acrylic acid sodium salt) (PAA, M.W. ˜15 kDa) was deposited by a linear potential sweep from 0.1 to 0.8 V vs. Ag/AgCl at a scan rate of 100 mV/s in a 1.0 mM aqueous solution of PAA. The resulting films were thoroughly rinsed with deionized water and then incubated in a 1.0 mM aqueous solution of poly(fluorescein isothiocyanate allylamine hydrochloride) for 15 min. Four additional rounds of 15-min incubation were given alternately in 1.0 mM PAA and poly(fluorescein isothiocyanate allylamine hydrochloride) so they reached a total of 10 layers at the end of the deposition. In each round, a UV-vis absorption spectrum of the resultant film was taken with a UV-visible spectrophotometer (Cary 50 Bio, Varian).

Results and Discussion

Electrochemical Treatments and Characterization. The following “trigger-and-trade” (TnT) scheme to electrostatically deposit polyanions, M⁺Poly⁻ was hypothesized, where M⁺ refers to the counterions, onto ferrocene-containing SAMs:

Fc-SAM-e⁻→Fc⁺-SAM 1)

Fc⁺-SAM+M⁺Poly⁻→Poly⁻Fc⁺-SAM+M⁺ 2)

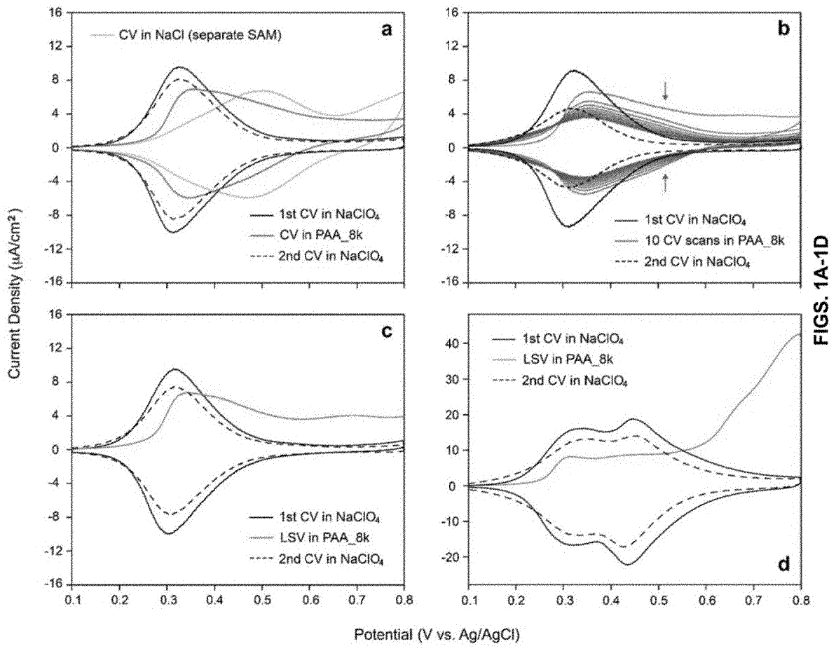

To test this hypothesis, cyclic voltammetry (CV) on 1:1 Fc-C11SH/C12SH mixed SAMs in poly(acrylic acid sodium salt) (PAA, M.W. 8000 Da) aqueous solutions was carried out. To diagnose the impact of such treatments on the SAMs, separate CV scans were also run on the same SAMs in 0.1 M NaClO₄ before and after each given treatment. As expected, the initial scan returns a symmetrical, bell-shaped voltammogram that is typical for electrode-bound ferrocenes probed in perchlorate (FIG. 1a). Compared to this standard response, the CV scan in PAA obtained afterwards displays moderately sluggish ferrocene oxidation with its peak lagging the former by about 30 mV (CV in red, FIG. 1a). This result confirms that 1 mM PAA, i.e., polymer plus its associated Na⁺, can sustain ferrocene oxidation sufficiently and in addition, reveals PAA's lower tendency to ion pair with ferrocenium (Fc⁺) as compared to perchlorate. By stabilizing the reaction product, such ion pairing effectively improves the kinetics of and lowers the driving force required for ferrocene oxidation.^{16,17} This effect is clearly shown by the significantly more sluggish oxidation profile obtained in Cl⁻, a poor ion-pairing agent¹⁸ to Fc⁺ (CV in gray, FIG. 1a). When this PAA/CV treated Fc-SAM was re-scanned in 0.1 M NaClO₄, a ˜14% decrease in the amount of electron transfer was observed (CV in dashed line, FIG. 1a). Two processes may potentially be responsible for this decrease: 1) ferrocene loss from the SAM and 2) the intended polymer deposition. In the first case, it is well documented that Fc SAMs probed in hydrophilic small ions such as Cl⁻ often suffer from electroactivity decays¹⁸⁻²⁰ upon extended potential bias, pointing to the susceptibility of ferrocenium (Fc⁺) to secondary reactions^{21,22} such as nucleophilic attacks when not properly protected, e.g., via ion pairing. To better gauge the contribution of this mechanism to the observed decay, fresh Fc-C11SH/C12SH mixed SAMs was examined under more stringent conditions. Subjected to 10 consecutive CV scans in PAA, the SAM displays progressively decreasing ferrocene redox features, with the largest decrease occurring during the first scan (FIG. 1b). Upon completion, this treatment registers a ˜45% decrease in redox activity of the SAM when probed in 0.1 M NaClO₄, which is comparable to the level of decrease obtained from SAMs similarly treated in 0.1 M NaCl (data not shown). In comparison, no appreciable loss was observed from SAMs similarly treated in 0.1 M NaClO₄. These results thus point to the likely occurrence of ferrocene loss from the SAM when oxidized in polyanion aqueous solutions. To minimize such losses, therefore, it is preferable to subject these Fc SAMs only to a short period of potential bias.

On the other hand, PAA deposition may as well induce Fc activity decrease either by lowering the amount of Fc available for oxidation (due to Fc⁺PAA⁻ complexation), or, by physically limiting perchlorate's access to the SAM surface (i.e., partial blocking) during the subsequent scan. Follow-up voltammetric measurements showed the first signs of this process. For example, when freshly prepared SAMs of the same composition were treated by a linear potential sweep (LSV) instead of CV in the presence of PAA, a larger decrease, ˜20%, was obtained (FIG. 1c). This result argues against the material-loss mechanism—or, at least not as the sole mechanism in operation, because the Fc SAM was under longer potential bias in the CV treatment, which would have led to a greater loss and hence a larger decrease in electroactivity. Rather, this observation can be readily explained by the deposition scheme, in that the backward potential scan reduces most Fc⁺ back to Fc, which lifts the electrostatic attraction and in turn causes some deposited PAA to desorb from the SAM. This was found to be indeed the case, for example, from fluorescence spectroscopic characterization (next section).

Additional voltammetric runs were also carried out using Fc SAMs of different compositions and on other polyanions. For example, when pure Fc SAMs were employed instead of Fc-C11SH/C12SH mixed SAMs, an LSV treatment in PAA leads to a ˜24% decrease of the ferrocene redox response (FIG. 1d), which is slightly larger than that obtained from the mixed Fc SAMs similarly treated. Provided that such a decrease is indeed indicative of polymer deposition, this result hints on the important possibility to control the amount of deposited polymer via Fc surface density in the SAM. On the other hand, the observation of similar trends was confirmed when different polyanions or polyanions of different molecular weights were examined. One of such measurements, based on 7.5 kDa poly(L-glutamic acid, sodium salt) and mixed Fc SAMs.

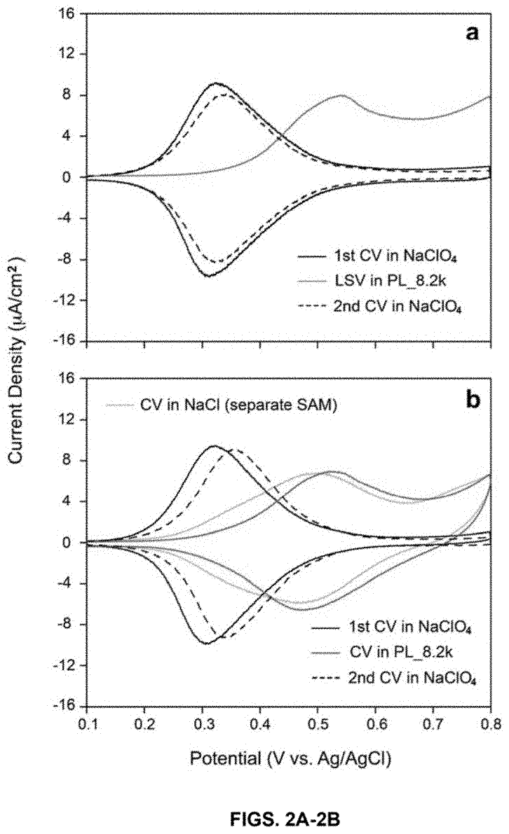

Similar voltammetric treatments were also extended to cationic polymers, which, surprisingly, led to partial activity loss in Fc-SAMs as well. As shown in FIG. 2a, this amounts to a 16% decrease after the 1:1 Fc-C11SH/C12SH mixed SAM is treated by a single LSV scan in a poly(L-lysine hydrochloride) (PL, M.W. 8200 Da) aqueous solution. This result is unexpected, as it stands to suggest deposition of polymers carrying the same (positive) charge as the surface. Compared to the case of anionic PAA, the LSV response obtained here displays significantly more sluggish ferrocene oxidation, whose peak lags the one obtained in NaClO₄ by >200 mV. When the mixed SAMs were treated with a single CV scan instead, a smaller (˜9%) decrease in ferrocene activity results (FIG. 2b). Here, interestingly, the second CV in NaClO₄ consistently emerges a few tens mVs more positive than the first one. This shift is likely due to the deposited PLs, whose presence modifies the local charge environment around the Fc moieties and makes electron removal from the latter more costly. Potential shifts of similar nature have been previously observed, for example, on binary SAMs containing ferrocenes²³ as well as redox-active polyelectrolyte films.²⁴ Such a positive shift is also discernable from the LSV-treated SAMs but not as large, ˜10 mV. In contrast, no shifts were found from the SAMs treated by either LSV or CV in the presence of PAA (FIG. 1). This characteristic shift, therefore, once again suggests polycation deposition on Fc SAMs upon electrooxidation. Another polycation tested, poly(allylamine HCl), produces even more pronounced sluggishness and shifts when similarly treated.

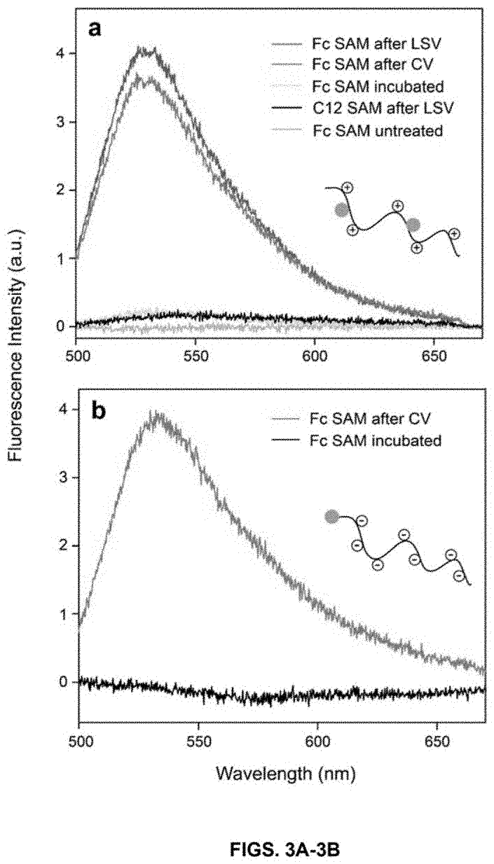

Fluorescence Spectroscopy. Shown in FIG. 3 are fluorescence emission spectra acquired directly on 1:1 Fc-C11SH/C12SH mixed SAM surfaces that have undergone various treatments with polyelectrolytes. The fluorophore probed here is fluorescein, which appears in the tested polycation in the form of poly(fluorescein isothiocyanate allylamine hydrochloride) and the polyanion, 5′-labeled adenine 25-mer. Due to existence of multiple complicating factors, such as fluorescence quenching (by gold²⁵ as well as ferrocene²⁶) and variations in polymer conformation and placement, the focus here was on identifying the trend in the signals. As evident from FIG. 3a, both single LSV and CV treatments lead to successful polycation deposition, with the former displaying slightly but consistently higher fluorescence intensity. By contrast, very little deposition resulted from the following controls: 1) 30-min incubation of the SAM in the polymer solution (i.e., no electrochemical treatment) or 2) a single LSV scan of pure C12 SAM in polymer (i.e., no ferrocene). These negative controls thus confirm the necessity of electrochemically modifying the surface charge of these SAMs in order to achieve polymer deposition. A similar trend is also observed in the case of polyanions (FIG. 3b). In accordance with the voltammetric evidence presented earlier, these results show a very minor polymer desorption upon the returning potential scan. Such irreversibility is generally observed in electrostatic polyelectrolyte deposition and points to the existence of other intermolecular forces, such as van der Waals and hydrophobic interactions, besides electrostatic attraction, in facilitating polymer surface binding.

Water Contact Angle Measurements. Water contact angles measurements were also conducted on these Fc-containing SAMs subjected to similar electrochemical treatments (Table 2). As expected, the untreated 1:1 Fc-C11SH/C12SH mixed SAM displays a relatively hydrophobic surface with a water contact angle of about 91°, which decreases only slightly after the SAM undergoes an LSV scan in water alone, 88°. By contrast, the SAM similarly treated in PAA gives a water contact angle of about 71°, indicating a more hydrophilic surface as a result of PAA deposition. If the SAM is treated by 10 consecutive CV scans instead, a very comparable angle, 72°, results, suggesting that deposition occurs mostly during the initial scan. On pure Fc SAMs, a lower angle, ˜64°, is observed upon the same LSV treatment, which is suggestive of a higher PAA surface coverage due to higher Fc density. In marked contrast, SAMs similarly treated in the presence of polycations only yield negligible (in the case of polylysine) to minor (in the case of polyallylamine) changes in water contact angles. These results thus point to the distinctive surface characteristics between deposited polyanions and polycations, which in turn suggest different deposition mechanisms involved.

TABLE 2
Water Contact Angle (in Degree) Measurements. All SAMs
Are Treated by an LSV Scan Unless Otherwise Specified

| | 1:1 Mixed Fc- | |
|---|---|---|
| Polymer | C11SH/C12SH | 100% Fc-C11SH |
| SAM alone | 90.7 ± 0.4^{a} | 82.8 ± 0.5^{a} |
| | 88.1 ± 0.5^{b} | |
| Poly(acrylic acid | 71.4 ± 0.6^{b} | 63.5 ± 1.5^{b} |
| sodium salt) | 72.1 ± 6.4^{c} | |
| Poly(L-lysine HCl) | 87.3 ± 0.2^{b} | 81.7 ± 3.6^{b} |
| Poly(allylamine HCl) | 82.6 ± 4.3^{b} | 86.9 ± 1.7^{b} |

^{a}Fresh SAM with no treatment; ^{b}LSV from 0.1 to 0.8 V vs. Ag/AgCl in water; ^{c}Ten consecutive CVs from 0.1 to 0.8 V in water; Standard deviation values are based on at least three parallel measurements obtained from either one or two samples.

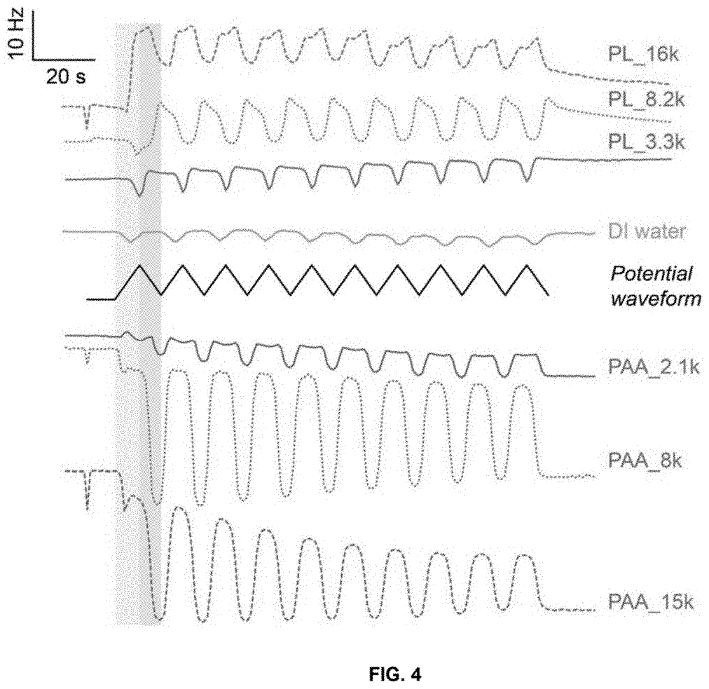

Electrochemical Quartz Crystal Microbalance (EQCM). The deposition of PAA and PL was followed, each in three molecular weights, using electrochemical quartz crystal microbalance. For the anionic PAA of 8 and 15 kDa, the crystal oscillation frequencies start to drop almost immediately after the potential sweep commences (dotted and dashed traces in green, FIG. 4), indicating mass gain at the SAM surface as a result of polymer deposition. In both cases, the drop is quickly replaced by a new frequency rise that reaches a local maximum at around 0.3 V vs. Ag/AgCl, thereby registering a frequency decrease of 4 Hz (8 kDa) and 5 Hz (15 kDa), respectively. Past the minimum, the frequency drops back down slowly toward the end of the forward potential scan at 0.8 V. Immediately following the start of the backward scan, a much larger frequency drop kicks in, producing a frequency decrease of 27 Hz (8 kDa) and 25 Hz (15 kDa) at the completion of the backward scan (regions highlighted in light blue, FIG. 4). On subsequent CV scans, the frequency profiles track the applied potential closely, but not exactly. On a closer look, it can be discerned that the frequency maxima/minima consistently precede the potential maxima/minima (0.8 V and 0.1 V, respectively). These frequency maxima/minima are not constant from scan to scan, moreover. As the potential scan proceeds, the maxima decrease progressively, while the minima increase, thus narrowing the frequency swing in between. This tendency is more pronounced in the case of 15 kDa PAA, measuring 11 Hz vs. 18 Hz for the 8 kDa PAA, at the end of the final CV scan. In both cases, a stable baseline follows the potential switch-off. In comparison to these two cases, the 2.1 kDa PAA similarly probed displays much smaller frequency shifts as well as a different shift profile (solid trace in green, FIG. 4). Starting off, the crystal oscillation frequency shifts downward only slightly, which is then superseded by a similar but more powerful frequency increase that produces a local maximum at around 0.25 V. From that point on, the frequency continues to drop till the forward scan completes, which, upon potential reversal, starts to rise again. This produces a new frequency maximum, beyond which the frequency drops sharply and reaches a minimum at the end of the backward scan. Consecutive CV scans afterwards produce a profile that generally resembles the other two cases, except that each frequency maximum now contains edges and between them a local minimum. On the other hand, control measurements conducted in water alone only yield a low-magnitude, despite potential-responding, profile, which reestablishes the initial frequency baseline at the end of each forward scan as well as at the completion of the consecutive CV treatment (solid trace in blue, FIG. 4).

Similar EQCM characterization of cationic PLs deposition reveals a number of distinctive features as compared to PAAs (traces in red, FIG. 4). 1) During the initial potential scan. For PLs of 3.3 and 8.2 kDa, the first forward scan lead to a monotonous frequency downshift starting at ˜0.3 V. The 16 kDa PL behaves quite differently, in that the frequency initially drops slightly and then rises abruptly at 0.4 V. 2) Subsequent potential cycles. Here, once again, PLs of 3.3 and 8.2 kDa share the same trend, in which the frequency increases/decreases are brought forth by the backward/forward potential scans, respectively; matching frequency/potential highs and lows are instead observed from the 16 kDa PL. 3) Extent of frequency fluctuation. In all three cases, the magnitude of frequency shifts becomes relatively stable after the first potential cycle. 4) Net frequency shifts. For all three PLs, a positive frequency shift in the range of 4-6 Hz results at the completion of the potential cycle. By contrast, all PAAs produce negative net frequency shifts: −9 Hz for the 2.1 kDa and about −28 Hz for the other two. 5) The smallest PL (3.3 kDa) displays relatively flat frequency maxima as opposed to peaks from the other two in the series, which in a way is consistent with the PAA series.

EQCM provides highly convoluted information about the deposition processes, because the deposited polymers simultaneously change the surface mass, viscoelasticity and SAM/water interfacial slippage condition, each modifying the crystal oscillation frequency in its own fashion.²⁷ Complicating the matter further are secondary processes caused by the applied potential bias, such as the swelling/shrinking of deposited polymers and accompanying ingress/egress of counterions and water. Fortunately, these secondary processes cannot take effect prior to polymer deposition. This thus points to the initial potential scan as the only window to observe the deposition alone, where the correspondence between frequency drops and polymer deposition suggests itself (yellow-highlighted region, FIG. 4). Once deposited, both polyanions and polycations will electrostatically respond to the applied potential, which continues to drive the Fc/Fc⁺ redox cycles. In the case of PAA, the reduction of Fc⁺ back to Fc on the returning scan (blue-highlighted region, FIG. 4) lifts the electrostatic attraction between Fc⁺ and PAA, producing a mechanically more relaxed and elastic structure. An influx of sodium ions, accompanied by their water shells, is also expected, so that the newly liberated negative charges on PAA can be neutralized. Collectively, these structural/compositional/mechanical changes register a large and abrupt frequency decrease on the oscillating crystal. The next forward potential sweep reverses the processes, whereupon a more adherent and rigid PAA layer enables the crystal to oscillate at a higher frequency. As the potential cycle continues, these processes repeat accordingly. Similar potential-modulated QCM responses have been observed previously, for example, from ferricyanide-doped polyelectrolyte films.¹⁴ Evaluating these PAA profiles together, two additional conclusions may be reached. First, the polyanion deposition is largely an irreversible process. This is evident from the similarity in QCM responses between the initial and subsequent scans, both operating on the same population of polymers deposited in the first scan. Such irreversibility is commonly found in LbL polyelectrolyte deposition²⁸ and can be generally attributed to 1) the large energy penalty associated with dissociating/rehydrating the surface and polymers, 2) the vanishingly small translational entropy²⁹ of polymers as compared to small solutes and 3) the presence of other binding mechanisms, such as van der Waals interactions. Second, beyond the initial scan, the applied potential acts to “anneal” the deposited polyanions, as manifested by the progressively decreasing magnitude of frequency shifts. Such annealing effect is most visible in the 15 kDa PAA, whose long polymer chain affords the highest number of loose segments that are mostly responsive to the electric field among the three. The other interpretation of the observed trend would be a gradual loss of PAA deposits from the surface, which is considered less likely because of its absence from the case of 2.1 kDa PAA. With its short chain carrying the same charge density, such loss would have been at least comparable to the other two PAAs, if not more.

On the polycation side, PL deposition on Fc SAMs can be unequivocally identified from their highly characteristic QCM profiles. Similar to PAAs, their deposition is electrochemically triggered and takes place during the initial scan. But unlike their anionic counterparts, which are electrostatically drawn to the oxidized Fc SAM, these polycations experience repulsion as they move toward and subsequently land on the similarly charged surface. To overcome this repulsion, therefore, their counterions, have to be directly involved. A detailed discussion on this mechanism will be presented in a separate section below. As the potential shifts toward more negative (reducing) values on the returning scan, the deposited PLs are pulled further in, which leads to an overall more compact structure and hence the observed frequency upshift. The next forward potential scan sets everything on reverse: a relaxed film displaying a frequency downshift. As the potential scan continues, such shrinkage/expansion processes take turn to dominate the resulting frequency response. These features are shared by the 3.3 and 8.2 kDa PLs, with their frequency maxima/minima completely “out of phase” with the applied potential. Between these two, the 3.3 kDa PL clearly responds to the applied potential faster than the other, likely due to its smaller size. In comparison, the frequency shift observed in the 16 kDa PL not only kicks in early but also is in phase with the applied potential. The latter feature, which notably resembles PAA's frequency profiles past the initial potential cycle, is not well understood at this moment.

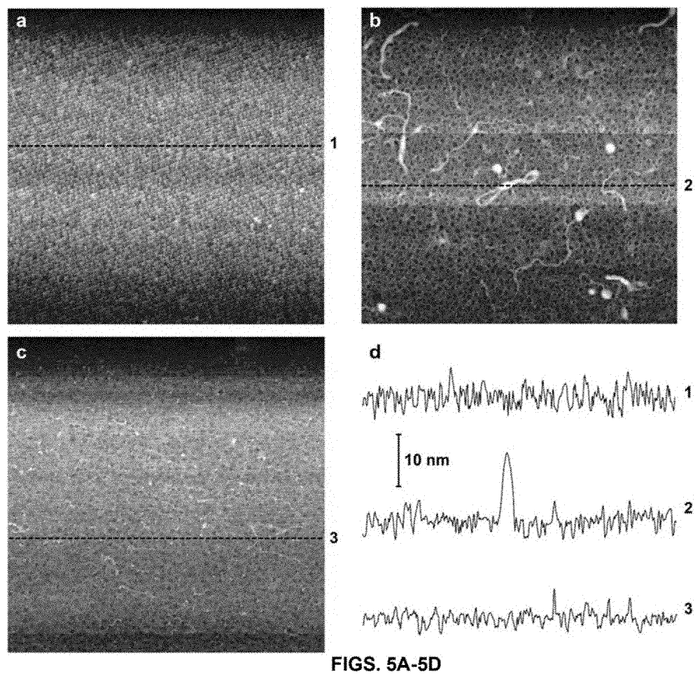

Atomic Force Microscopy (AFM). To gain detailed information on the morphology of thus deposited polyelectrolytes, AFM measurements were also carried out. For the 15 kDa PAA LSV-deposited on the Fc mixed SAM, the resultant image appears largely featureless (FIG. 5a). Since 15 kDa PAA is too small to be individually resolved with our current AFM setup, we cannot conclude from this image whether or not polyanion deposition has occurred. Similar results were also obtained from the 16 kDa PL as well as control samples run in water alone. To circumvent this limitation, PAA was replaced with DNA from calf thymus, a much larger polyanion with a M.W. of 10-15 MDa. This time, AFM imaging clearly identifies twisted, thread-like features spanning several hundred nm (FIG. 5b), which can be attributed to deposited DNAs with reasonable certainty. From their large sizes, i.e., tens of nm in width and >10 nm maximal height, it was concluded that these threads represent bundles of DNA strands, whose formation may result from DNA minimizing hydrophobic contact. Beneath these DNA bundles, interestingly, another mesh-like feature is also clearly visible. These meshes are relatively evenly distributed across the entire surface and their sizes fall within a narrow range of 15-20 nm. Since this formation is exclusively observed for DNA, i.e., absent from SAMs similarly treated in PAA, PL or water alone, we tentatively assign it to be the second main feature of DNA deposition besides the threads. To further verify this assignment, DNA deposits that formed were imaged on pure Fc SAMs, which, once again, display a mesh-like morphology (FIG. 5c). Here, a noticeable difference is that the DNAs deposited atop appear not only thinner but also shorter, which appear to resemble individual DNAs more than their bundles. This morphological difference may be due to the fact that, absent of hydrophobic C12 thiols, pure Fc SAMs produce a primarily charged surface upon oxidization, which can better accommodate binding of individual DNAs. By contrast, oxidation of the Fc-C11SH/C12SH mixed SAM yields a partially charged surface blended with hydrophobic components. From these images, it was concluded that such electrochemically triggered polymer deposition proceeds evenly across the entire SAM surface.

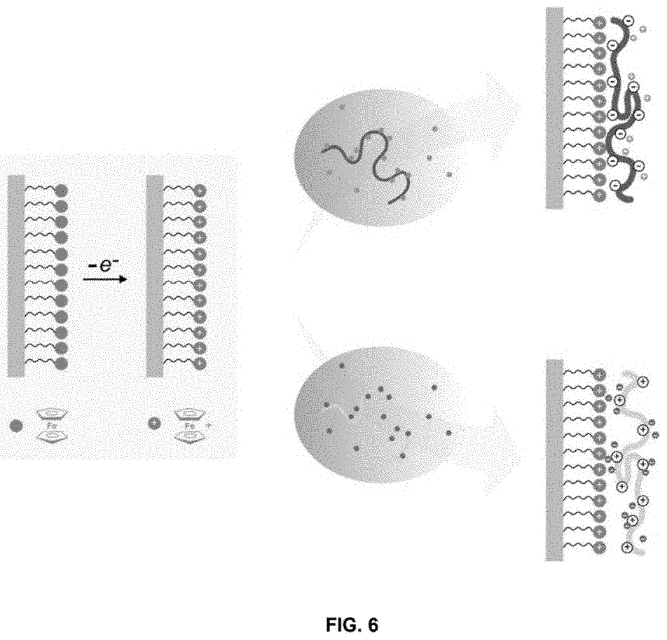

Deposition Mechanisms. All the experimental evidence presented above suggests that the “trigger-and-trade” scheme describes the polyanion deposition reasonably well. Among these, the results of fluorescence, contact angles and AFM uniformly confirm the occurrence of such deposition, whereas the CV and EQCM data further shed light on the involved mechanism and dynamics. Of the latter, the well-defined Fc oxidation waves obtained in PAA (FIG. 1) and poly(glutamic acid, sodium salt) manifest their direct involvement and efficacy in charge compensation, despite their relatively low concentration and large size (e.g., vs. 0.1 M NaCl). The EQCM responses of PAA (FIG. 4) during the initial potential scan, on the other hand, identify a trend in which the mass gain on the electrode closely tracks the Fc oxidation. These results help establish a general sequence of events involved in the deposition: ferrocene oxidation→charge compensation→polyanion deposition (FIG. 6).

The characteristically distinctive responses observed in polycations signify a different deposition mechanism all together. This becomes evident first from voltammetry, in which Fc oxidation in the presence of polycations is found to significantly lag behind that obtained in polyanion solutions. Of these, the CV obtained in PL closely resembles that in NaCl (FIG. 2b), suggesting that chloride, the common anion of the two electrolytes, is responsible for compensating Fc⁺. Nevertheless, these two voltammograms are not exactly identical: Fc oxidation in NaCl not only appears slightly more dragged out, but also peaks earlier than the other. The latter shift is not caused by conductivity difference between the two solutions (i.e., the iR drop), which remains observable in 1 mM as well as 1.0 M NaCl solutions (data not shown). A similar but even more pronounced trend was found in the case of poly(allylamine HCl). These distinctive features thus lead us to an important conclusion: the movement of small counterions in polyelectrolyte aqueous solutions is not completely independent of the polymer. For this to be true, therefore, a certain level of association must exist between polyelectrolytes and their counterions when dispersed in water. Understandably, the strength and extent of such association is polymer dependent. In the case of PL, the pendant positive charge is located on the ε-position distant from the polymer backbone, which gives rise to a relatively “delocalized” charge distribution along the polymer. This in effect lowers the density of intrinsic charge carried by the polyanion and thus undermines its ability to electrostatically attract its counterion, Cl⁻. As a result, a significant portion of chloride ions in the system can move about nearly as freely as in NaCl. By contrast, charges are more locally distributed along the polymer in the case of poly(allylamine HCl), thanks to the close placement of its ammonium group to the polymer backbone. This results in a higher level of association between polymers and their counterions at any given time, due to stronger electrostatic attraction and an elevated need to screen the monomer-monomer charge repulsion within the polymer. Consequently, to call these polymer-associated counterions to participate in charge compensation, a higher energy input is required, as manifested by its positive-shifted Fc oxidation potential. Once these chloride ions start to move toward the electrode, critically, they drag the associated polymers along with them. To see the feasibility of this potential-induced co-movement, an analogy with another electrokinetic phenomenon was invoked—electroosmosis (EO). In the latter process, counterions accumulated in the double layer of a charged surface can carry water molecules to produce bulk solution movement under an external electric field.³¹ With their stronger (charge-charge vs. charge-dipole interaction in EO) and multiple binding with polycations in the current case are expected to be even more susceptible to such induced motion. Accepting this possibility for the time being, another important conclusion was reached: electrochemically triggered polycation deposition involves like-charge attraction. This has to be true because the polymer plus associated counterions are net positively charged—the same as the oxidized Fc SAM.

Additional insights emerge when these electrochemically-triggered processes are evaluated in light of established polyelectrolyte theories. In the classical Oosawa-Manning (OM) ion condensation theory,³²⁻³⁴ small counterions are postulated to distribute between two states in aqueous polyelectrolyte solutions: freely mobile vs. territorially bound with polymers. Underlying this distribution is the thermodynamic balance between electrostatic attraction, which pulls the counterions within close proximity to the polymer, and the entropic gain associated with the release of counterions into the bulk. A key parameter formulated in the OM theory is Manning linear charge density of the polyelectrolyte, ξ which can be calculated from equation, ξ=e²/εk_{B}Tb, where e is the elementary charge, ε the dielectric constant of the solvent, k_{B}T the thermal energy term and b the average axial charge spacing of the polymer. Theoretically, counterion condensation sets in whenever ξ becomes greater than 1.^{33,34} From this dimensionless quantity, one can also estimate the fraction of condensed ions, f, which takes the value of 1−(Zξ)⁻¹, where Z is the valence charge of the counterion. Approximating b to be 0.3 nm for poly(allylamine HCl),³⁵ ξ=2.3 and f=0.6 (in water and at 25° C.) was obtained, which suggest substantial ion condensation. In comparison, such condensation is considerably less in the case of PL due to its larger charge spacing, e.g., in the range of 0.5-0.7 nm, depending on its secondary structure.³⁶ These numerical estimates thus corroborate well with our qualitative analysis above.

An important implication of ion condensation theory is attraction between polyelectrolytes carrying similar charges. This counterintuitive phenomenon arises because 1) the polyelectrolyte plus its counterions is a highly polarizable entity; as such, 2) thermal fluctuation causes temporary, but constant, uneven charge distribution along the polymer; and 3) correlated polarization between polyelectrolytes in close proximity lowers the total energy of the system. The latter, as Oosawa put forth first in his celebrated monograph, Polyelectrolytes, “ . . . results in an attractive force between macroions, just as in the case of van der Waals interaction between atoms and molecules”.³² This thus leads to a peculiar scenario in which mobile ion clouds are shared by interacting polymers.³⁷ While this phenomenon is prevalent and relatively well understood in cases where polyvalent counterions are directly involved, e.g., in DNA/dication binding,^{38,39} recent theoretical and experimental evidence^{37,40} strongly suggests that like-charge attraction can be also mediated by monovalent ions. Besides polyelectrolytes, similar theoretical treatments⁴¹ can also be extended to explain attraction between like-charged surfaces. In this regard, therefore, our results on polycation deposition provide experimental evidence that the hybrid scenario, i.e., attraction between similarly charged polyelectrolytes and surfaces, also occurs (FIG. 6).

Still, such attraction would not proceed without the electrochemical trigger. Electrooxidation not only puts charge on the Fc-SAM surface but, in doing so, also provides the driving force for polyelectrolytes (i.e., polymers plus counterions) to migrate toward the surface. In between the two binding parties, importantly, the applied potential also tips the thermodynamic and mechanical balances at the Fc-SAM/water interface. Prior to oxidation, both mixed and pure Fc SAMs are moderately hydrophobic (Table 2). To cope with such hydrophobicity and at the same time maximally maintain their H-bonding network, water molecules in direct contact with the surface collectively will have to adopt a certain nonrandom orientation. As oxidation brings charges onto the hydrophobic SAM, many interfacial water molecules find themselves in wrong orientations so a major restructuring is due. Similar processes can also be expected of the incoming polyelectrolytes. In the case of polyanions, these may involve shedding of counterions and reorganization of polymer segments, presumably guided by the local surface charge distribution, so that Fc⁺ moieties can be neutralized fully and effectively. Such restructuring should be less for polycations, because their binding to Fc⁺ is led by small counterions (no shedding is necessary, therefore), whose nimble movement allows quick adjustment of charge distribution around the polymers. This important distinction between polyanions and polycations is expected to cause further divergences after their landing, i.e., conformation/packing of deposited polyelectrolytes as well as the associated interfacial water structure. Such microscopic characteristics, in turn, lead to experimentally observable differences, e.g., the constantly smaller signal fluctuations and deviations in EQCM (FIG. 4) and water contact angles (Table 2) obtained from polycations.

While the mechanisms discussed above are clearly plausible, it must be stressed that other parameters and scenarios, either operating alone or alongside electrostatic interactions, may also exist. For example, it was not explicitly considered the influence of lateral surface heterogeneity, which can be particularly relevant in the case of mixed Fc SAMs. In the case of polycations, moreover, deposition may as well result from their decreased solubility as the Cl⁻ exodus (upon Fc oxidation) causes the deprotonation, hence neutralization, of these polymers. All these potential contributors attest the complexity of involved processes, which we hope to continue to explore in the near future.

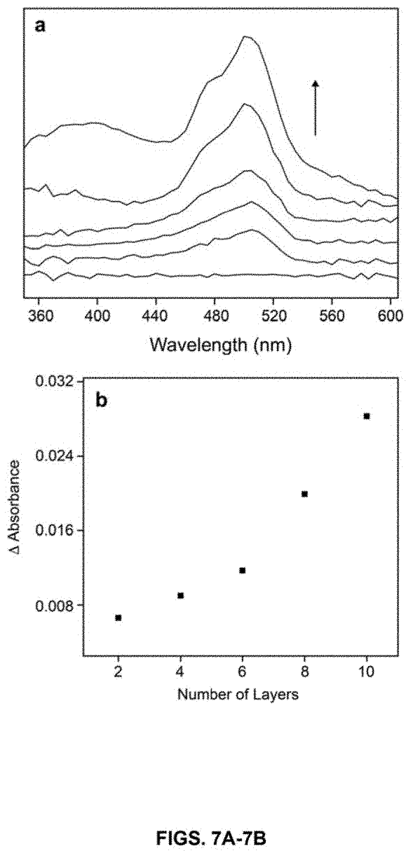

Layer-by-Layer Deposition. Finally, as a preliminary effort to explore the potential applications of this deposition strategy, the formation of conventional layer-by-layer (LbL) polyelectrolyte films was examined starting with an electrochemically deposited first polyelectrolyte layer. This, if successful, should promise a general formation strategy for electroactive LbL films, whose ferrocene adlayer can be exploited for both diagnosis and electroactuation purposes. As shown in FIG. 7, PAA films LSV-deposited on pure Fc-C11SH SAMs can indeed serve as the starting surface to sustain the growth of LbL polyelectrolyte films. For the 10-layer PAA/poly(fluorescein isothiocyanate allylamine) films investigated here, moreover, a nonlinear layer-by-layer growth profile was observed.

Summary

A new approach to polyelectrolyte surface deposition based on electrochemical triggering has been presented. Starting from the same basic structure, ferrocene-decorated self-assembled monolayers (Fc-SAMs), this approach enables quantitative deposition of both polyanions and polycations with a wide range of chemical identities (synthetic polymers, peptides and DNA) and molecular weights (10³ to 10⁷ Da). Such generality, combined with its ready access to conventional layer-by-layer film formation and electrochemical detection, should make this approach useful in a number of areas, for examples, in polyelectrolyte-based diagnosis and electroactuation. Conceivably, the methodology detailed here may also be of some value in probing aqueous polyelectrolyte systems, in particular, their organization and mass transfer. To this end, for example, Osteryoung and coworkers demonstrated previously that quantitative information about counterion diffusion (in polyelectrolyte solutions⁴² and their colloidal suspensions⁴³) could be extracted from steady-state voltammetry of proton reduction on microelectrodes. Compared to their approach, our Fc-SAM-based methodology imposes little restriction on experimental conditions under which the polyelectrolytes can be examined, such as pH or the type of ions. As such, it enables counterions in polyelectrolytes to be directly compared to their simple ion counterparts. While a fair amount of information can already be obtained from Fc/Fc⁺ voltammetry alone, such as shape, shift and onset, additional information is possible when it is further coupled with a secondary technique, e.g., QCM.

### REFERENCES

1. Love, J. C.; Estroff, L. A.; Kriebel, J. K.; Nuzzo, R. G.; Whitesides, G. M. Self-Assembled Monolayers of Thiolates on Metals as a Form of Nanotechnology. Chem. Rev. 2005, 105, 1103-1169.
2. Chidsey, C. E. D. Free Energy and Temperature Dependence of Electron Transfer at the Metal-Electrolyte Interface. Science 1991, 251, 919-922.
3. Smalley, J. F.; Finklea, H. O.; Chidsey, C. E. D.; Linford, M. R.; Creager, S. E.; Ferraris, J. P.; Chalfant, K.; Zawodzinsk, T.; Feldberg, S. W.; Newton, M. D. Heterogeneous Electron-Transfer Kinetics for Ruthenium and Ferrocene Redox Moieties through Alkanethiol Monolayers on Gold. J. Am. Soc. Chem. 2003, 125, 2004-2013.
4. Eckermann, A. L.; Feld, D. J.; Shaw, J. A.; Meade, T. J. Electrochemistry of Redox-active Self-Assembled Monolayers. Coord. Chem. Rev. 2010, 254, 1769-1802.
5. Umek, R. M.; Lin, S. W.; Vielmetter, J.; Terbrueggen, R. H.; Irvine, B.; Yu, C. J.; Kayyem, J. F.; Yowanto, H.; Blackburn, G. F.; Farkas, D. H.; Chen, Y.-P. Electronic Detection of Nucleic Acids—A Versatile Platform for Molecular Diagnostics. J. Mol. Diagn. 2001, 3, 74-84.
6. Fan, C.; Plaxco, K. W.; Heeger, A. J. Electrochemical Interrogation of Conformational Changes as a Reagentless Method for the Sequence-Specific Detection of DNA. Proc. Natl. Acad. Sci. USA 2003, 100, 9134-9137.
7. Norman, L. L.; Badia, A. Redox Actuation of a Microcantilever Driven by a Self-Assembled Ferrocenylundecanethiolate Monolayer: An Investigation of the Origin of the Micromechanical Motion and Surface Stress. J. Am. Soc. Chem. 2009, 131, 2328-2337.
8. Imahori, H.; Yamada, H.; Nishimura, Y.; Yamazaki, I.; Sakata, Y. Vectorial Multistep Electron Transfer at the Gold Electrodes Modified with Self-Assembled Monolayers of Ferrocene-Porphyrin-Fullerene Triads. [symbol] J. Phys. Chem. B 2000, 104, 2099-2108.
9. Xie, H.; Jiang, K.; Zhan, W. Modular Molecular Photovoltaic System Based on Phospholipid/Alkanethiol Hybrid Bilayers: Photocurrent Generation and Modulation. Phys. Chem. Chem. Phys. 2011, 13, 17712-17721.
10. Clark, S. L.; Montague, M.; Hammond, P. T. Selective Deposition in Multilayer Assembly: SAMs as Molecular Templates. Supramol. Sci. 1997, 4, 141-146.
11. Harris, J. J.; Bruening, M. L. Electrochemical and in Situ Ellipsometric Investigation of the Permeability and Stability of Layered Polyelectrolyte Films. Langmuir 2000, 16, 2006-2013.
12. Hodak, J.; Etchenique, R.; Calvo, E. J.; Singhal, K.; Bartlett, P. N. Layer-by-Layer Self-Assembly of Glucose Oxidase with a Poly(allylamine)ferrocene Redox Mediator. Langmuir 1997, 13, 2708-2716.
13. Lvov, Y. M.; Lu, Z.; Schenkman, J. B.; Zu, X.; Rusling, J. F. Direct Electrochemistry of Myoglobin and Cytochrome P450_{cam} in Alternate Layer-by-Layer Films with DNA and Other Polyions. J. Am. Soc. Chem. 1998, 120, 4073-4080.
14. Grieshaber, D.; Vörös, J.; Zambelli, T.; Ball, V.; Schaaf, P.; Voegel, J.-C.; Boulmedais, F. Swelling and Contraction of Ferrocyanide-Containing Polyelectrolyte Multilayers upon Application of an Electric Potential. Langmuir 2008, 24, 13668-13676.
15. Schmidt, D. J.; Cebeci, F. Ç.; Kalcioglu, Z. I.; Wyman, S. G.; Ortiz, C.; Van Vliet, K. J.; Hammond, P. T. Electrochemically Controlled Swelling and Mechanical Properties of a Polymer Nanocomposite. ACS Nano 2009, 3, 2207-2216.
16. Rowe, G. K.; Creager, S. E. Redox and Ion-Pairing Thermodynamics in Self-Assembled Monolayers. Langmuir 1991, 7, 2307-2312.
17. Ju, H.; Leech, D. Effect of Electrolytes on the Electrochemical Behavior of 11-(Ferrocenylcarbonyloxy)undecanethiol SAMs on Gold Disk Electrodes. Phys. Chem. Chem. Phys. 1999, 1, 1549-1554.
18. Valincius, G.; Niaura, G.; Kazakevičiene, B.; Talaikytė, Z.; Kažemėkaitė, M.; Butkus, E.; Razumas, V. Anion Effect on Mediated Electron Transfer through Ferrocene-Terminated Self-Assembled Monolayers. Langmuir 2004, 20, 6631-6638.
19. Popenoe, D. D.; Deinhammer, R. S.; Porter, M. D. Infrared Spectroelectrochemical Characterization of Ferrocene-Terminated Alkanethiolate Monolayers at Gold. Langmuir 1992, 8, 2521-2530.
20. Abbott, N. L.; Whitesides, G. M. Potential-Dependent Wetting of Aqueous Solutions on Self-Assembled Monolayers Formed from 15-(Ferrocenylcarbonyl)pentadecanethiol on Gold.

Langmuir 1994, 10, 1493-1497.
21. Jego-Evanno, P.; Hurvois, J. P.; Moinet, C. Electrooxidation of Substituted Ferrocenes: Indirect Oxidation of the Side Chain. J. Electroanal. Chem. 2001, 507, 270-274.
22. Hurvois, J. P.; Moinet, C. Reactivity of Ferrocenium Cations with Molecular Oxygen in Polar Organic Solvents: Decomposition, Redox reactions and Stabilization. J. Organomet. Chem. 2005, 690, 1829-1839.
23. Lee, L. Y. S.; Sutherland, T. C.; Rucareanu, S.; Lennox, R. B. Ferrocenylalkylthiolates as a Probe of Heterogeneity in Binary Self-Assembled Monolayers on Gold. Langmuir 2006, 22, 4438-4444.
24. Tagliazucchi, M.; Calvo, E. J.; Szleifer, I. A Molecular Theory of Chemically Modified Electrodes with Self-Assembled Redox Polyelectrolye Thin Films: Reversible Cyclic Voltammetry. Electrochim. Acta 2008, 53, 6740-6752.
25. Kittredge, K. W.; Fox, M. A.; Whitesell, J. K. Effect of Alkyl Chain Length on the Fluorescence of 9-Alkylfluorenyl Thiols as Self-Assembled Monolayers on Gold. [symbol] J. Phys. Chem. B 2001, 105, 10594-10599.
26. Fery-Forgues, S.; Delavaux-Nicot, B. Ferrocene and Ferrocenyl Derivatives in Luminescent Systems. [symbol] J. Photochem. Photobiol. A 2000, 132, 137-159.
27. Buttry, D. A.; Ward, M. D. Measurement of Interfacial Processes at Electrode Surfaces with the Electrochemical Quartz Crystal Microbalance. Chem. Rev. 1992, 92, 1355-1379.
28. Dubas, S. T.; Schlenoff, J. B. Factors Controlling the Growth of Polyelectrolyte Multilayers. Macromolecules 1999, 32, 8153-8160.
29. Netz, R. R.; Andelman, D. Neutral and Charged Polymers at Interfaces. Phys. Rep. 2003, 380, 1-95.
30. Nguyen, K.-L.; Dionne, E. R.; Badia, A. Redox-Controlled Ion-Pairing Association of Anionic Surfactant to Ferrocene-Terminated Self-Assembled Monolayers. Langmuir 2015, 31, 6385-6394.
31. The Colloidal Domain. Evans, D. F. and Wennerström, H. Wiley-VCH: New York, N.Y., 1999.
32. Polyelectrolytes. Oosawa, F. Marcel Dekker, Inc.: New York, N.Y., 1971.
33. Manning, G. S. Counterion Binding in Polyelectrolyte Theory. Acc. Chem. Res. 1979, 12, 443-449.
34. Manning, G. S.; Ray, J. Fluctuations of Counterions Condensed on Charged Polymers. Langmuir 1994, 10, 962-966.
35. Donath, E.; Walther, D.; Shilov, V. N.; Knippel, E.; Budde, A.; Lowack, K.; Helm, C. A.; Möhwald, H. Nonlinear Hairy Layer Theory of Electrophoretic Fingerprinting Applied to Consecutive Layer by Layer Polyelectrolyte Adsorption onto Charged Polystyrene Latex Particles. Langmuir 1997, 13, 5294-5305.
36. Dos, A.; Schimming, V.; Tosoni, S.; Limbach, H.-H. Acid-Base Interactions and Secondary Structures of Poly-L-Lysine Probed by ¹⁵N and ¹³C Solid State NMR and Ab initio Model Calculations. [symbol] J. Phys. Chem. B 2008, 112, 15604-15615.
37. Naji, A.; Jungblut, S.; Moreira, A. G.; Netz, R. R. Electrostatic Interactions in Strongly Coupled Soft Matter. [symbol] Physica A 2005, 352, 131-170.
38. Gelbart, W. M.; Bruinsma, R. F.; Pincus, P. A.; Parsegian, V. A. DNA-Inspired Electrostatics. Phys. Today 2000, 9, 38-44.
39. Diehl, A.; Carmona, H. A.; Levin, Y. Counterion Correlations and Attraction between Like-Charged Macromolecules. Phys. Rev. E 2001, 64, 011804.
40. Manning, G. S. Counterion Condensation Theory of Attraction Between Like Charges in the Absence of Multivalent Counterions. [symbol] Eur. Phys. J. E 2011, 34, 132.
41. Guldbrand, L.; Jönsson, B.; Wennerström, H.; Linse, P. Electrical Double Layer Forces. A Monte Carlo Study. [symbol] J. Chem. Phys. 1984, 80, 2221-2228.
42. Ciszkowska, M.; Osteryoung, J. G. Voltammetric Studies of Counterion Transport in Polyelectrolyte Solutions. J. Phys. Chem. 1994, 98, 3194-3201.
43. Roberts, J. M.; Linse, P.; Osteryoung, J. G. Voltammetric Studies of Counterion Diffusion in the Monodisperse Sulfonated Polystyrene Latex. Langmuir 1998, 14, 204-213.

Electrochemically Triggered Interfacial Deposition/Assembly of Aqueous-Suspended Colloids

Experimental Detail

Chemicals. 11-Ferrocenyl-1-undecanethiol (Fc-C11SH), 1-dodecanethiol (C12SH), sodium perchlorate hydrate (99.99% trace metal basis), sodium chloride 99.5%), TWEEN 20 were products of Sigma-Aldrich (St. Louis, Mo.). Fluorescent carboxylate-modified polystyrene nanospheres/microspheres were obtained from Bangs Laboratories, Inc. (Fishers, Ind.). Deionized water of 18.2 MO cm (Millipore) was used in preparing all aqueous colloid suspensions as well as in all rinsing and dilution steps.

Formation of Self-Assembled Monolayers. Self-assembled monolayers (SAMs) containing Fc-C11SH/C12SH binary mixtures formed on semi-transparent gold-coated microscope slides (Au thickness: 10 nm, Sigma-Aldrich) were used throughout this work. These SAMs were prepared in two fashions as follows:

1) Solution incubation. Prior to the SAM formation, gold-coated substrates were immersed in a piranha solution (3:1 v/v mixture of concentrated H₂SO₄ and H₂O₂ 30 wt % aqueous solution) for 3 min, thoroughly rinsed with deionized water, ethanol, and then dried under N₂. Thus cleaned dry substrates were immediately immersed in an ethanol solution containing 0.5 mM Fc-C11SH and C12SH each; the incubation was allowed to proceed for 16-18 h in the dark. Upon completion, the substrates were rinsed first with methanol to remove excess thiols on surface, then DI water, and finally dried under N₂. These SAM-covered gold slides were normally used within the same day of their preparation.

2) Microcontact printing. Silicone rubber stamps, containing either circular pillar arrays or custom micropatterns, were obtained from Research Micro Stamps (Clemson, S.C.). Of the latter, hand-drawn features were first converted to digital files with a digital camera and shrunk to desired sizes in Adobe Illustrator (version: CS6); the resulting miniaturized patterns were saved in .svg format and subsequently passed to the manufacturer for stamp production. Before use, the stamps were first cleaned by sonicating in ethanol for 5 min, and gently dried under a stream of N₂. To ink, thus cleaned stamps were soaked in an ethanol solution of 0.5 mM Fc-C11SH and C12SH each for 10 min and then gently dried under N₂. Immediately afterwards, these inked stamps were placed conformally onto precleaned gold-coated glass slides; the printing was allowed to proceed for 10 min, during which a small weight block was placed on top of the stamp to ensure a gentle and even press. Upon completion, the stamps were removed, and the substrates were thoroughly rinsed with methanol, then DI water, and dried under N₂. These SAM-patterned gold slides were normally used within the same day of their preparation.

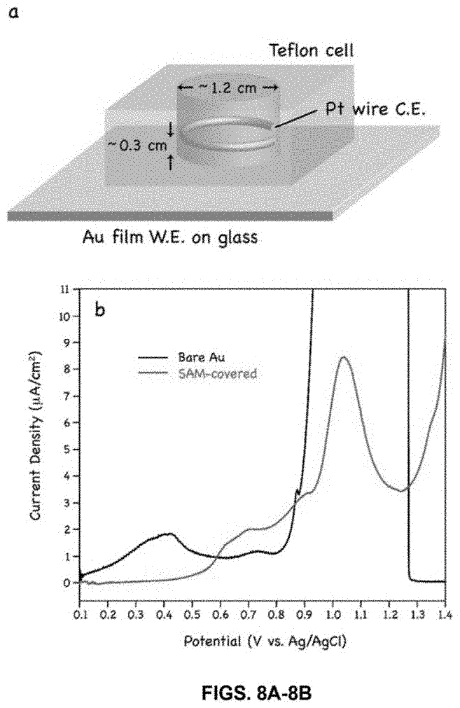

Electrochemical Treatments and Characterization. Linear sweep voltammetry (LSV) operated by a PC-controlled potentiostat (CHI 910B, CH Instruments, Austin, Tex.) was used in this work to initiate colloidal deposition and assembly on electrodes. A three-electrode setup was used throughout this work, consisting SAM-covered gold substrates as the working electrode, a platinum wire (diameter: 1 mm) as the counter electrode and Ag/AgCl in saturated KCl solution as the reference electrode, housed in homemade Teflon cells (FIG. 8). To initiate the deposition, a given SAM was typically biased with an LSV scan in an intended colloid suspension in 0.05% (w/v) aqueous solution of TWEEN 20. After LSV scan, the initial suspension was thoroughly exchanged out with deionized water, and the gold electrode thus treated was taken out and dried under a gentle stream of ultrapure N₂. Deposits can also be formed from colloids suspended in DI water without adding TWEEN 20 but with a slightly inferior reproducibility.

Zeta potential measurements. Zeta potential values of polystyrene nanobeads and microbeads suspended in DI water were obtained from a Malvern Zetasizer (Nano-ZS, Malvern Instruments, Worcestershire, UK) using capillary cells (DTS1070) operated under a 150-V bias at 25° C. Typically three parallel readings were taken for each sample.

Electrochemical Quartz Crystal Microbalance (EQCM). EQCM measurements were carried out at room temperature using a QCM analyzer with a 5 MHz crystal oscillator (Model: QCM25) from Stanford Research Systems (Sunnyvale, Calif.). The quartz crystals used are polished quartz wafers of 1-inch diameter with circular gold electrodes coated on both sides. Before use, these golf-coated quartz crystals were cleaned and grafted with a 1:1 Fc-C11SH/C12SH mixed SAM as described above. The SAM-coated crystal was subsequently mounted on the QCM crystal holder, and its solution-facing electrode was used as the working electrode in a three-electrode configuration together with a Pt-wire counter electrode and a Ag/AgCl reference electrode (in saturated KCl). To do so, a PC controlled potentiostat (CHI 910B, CH Instruments) was connected to the QCM crystal holder via the crystal face bias connector of the QCM25 crystal controller. This setup enables simultaneous monitoring of the QCM frequency shift and current on the working electrode (crystal) as a function of the applied potential; the latter is furnished by the potentiostat in the form of LSV between 0.1 and 0.9 V at 10 mV/s.

Fluorescence Microscopy. Fluorescence images were acquired on a Nikon A1+/MP confocal scanning laser microscope (Nikon Instruments, Inc., Melville, N.Y.) with 4× and 10× objectives. Laser beams at 488 and 561 nm were used to excite green- and red-emitting colloidal bead assemblies formed on semi-transparent gold-coated glass slides, and the corresponding emission signals were filtered at 525±25 and 595±25 nm, respectively.

Results and Discussion

Experimental Setup and Background Electrode Responses. FIG. 8a depicts schematically the experimental setup employed in this work. At the top is a Teflon cell, which contains a cylindrical through-hole as the solution reservoir at the center and two smaller slant side holes housing a Ag/AgCl reference electrode and a Pt wire counter electrode. The ring-shaped Pt wire is positioned roughly in parallel with the bottom gold-film working electrode, 0.3 cm above. As colloidal samples, carboxylate polystyrene (PS-COOH) beads of six different sizes suspended in DI water, with/without additional supporting electrolytes, were employed. These beads are fluorescently labeled so their deposition/assembly at the semi-transparent gold film electrodes can be fully followed with fluorescence microscopy. Besides size, these beads also differ each other in surface —COOH density, which is reflected by their various zeta potentials that range from −20 to −70 mV (Table 3).

TABLE 3
General properties of carboxylate polystyrene
(PS-COOH) beads studied.

| Size | Parking | Zeta | Bead |
|---|---|---|---|
| (μm) | area^{a} | potential (mV) | concentration^{c} |
| 0.06 | 57.2 | −20.9 ± 2.2^{b} | 9.58 × 10¹⁰ |
| 0.22 | 30.2 | −36.3 ± 0.7^{b} | 2.39 × 10¹⁰ |
| 0.51 | 9.4 | −35.6 ± 0.5^{b} | 9.58 × 10⁹ |
| 1.0 | 21.8 | −49.4 ± 0.4^{b} | 4.78 × 10⁹ |
| 2.19 | 186.2 | −51.0 ± 2.1^{b} | 4.28 × 10⁸ |
| 4.95 | 23.8 | −69.1 ± 0.7^{b} | 1.40 × 10⁷ |

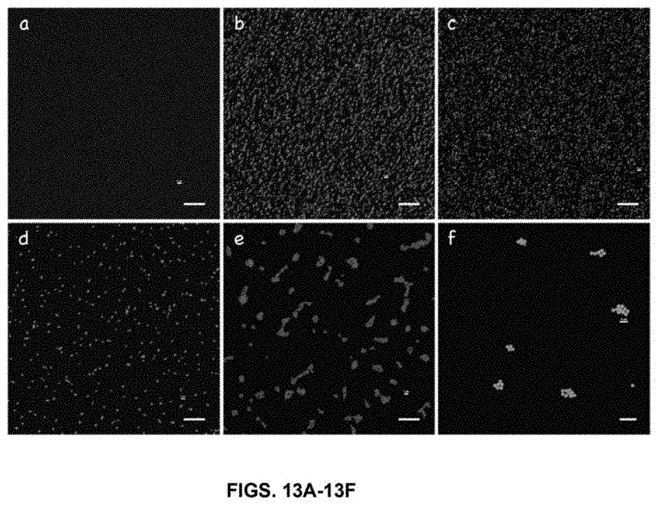

^{a}Average surface area (Å²) corresponding to each —COOH group, manufacturer's data; ^{b}Standard deviation, n = 3; ^{c}Count of beads per mL of samples employed in FIG. 13.

To identify the background electrochemical responses, we first ran linear sweep voltammetry (LSV) with this setup filled with DI water alone. With bare Au films as the working electrode, this yielded an i-V curve containing three main redox features (FIG. 8b, voltammogram in black). The first two broad peaks between 0.4 and 0.8 V appear to correspond to the monolayer and multilayer gold oxide formation,^{[21,22]} whereas the rise in current past 0.9 V is associated with oxygen evolution. The latter process apparently overloads the 10-nm-thick Au films, causing their complete strip-off from the glass slides evident to the naked eye (not shown). With the film gone, the cell loses its electrical contact past 1.3 V. For Au films covered with 1:1 Fc-C11SH/C12SH mixed SAMs, on the other hand, a quite distinctive LSV profile results (FIG. 8b, voltammogram in red). Here, the first pair of redox features are shifted to more positive potentials by about 0.2 V, likely a result of the SAM shielding the Au surface from water and thus hindering gold oxide formation. Following this pair is a prominent, symmetrical wave between 0.9 and 1.2 V, which can be attributed to the delayed Fc oxidation. Comparing the magnitude of this wave with that obtained in NaClO₄ (see below), it appears that this feature is contributed by some other background processes, perhaps e.g., continual oxide formation. After 1.2 V, the oxygen evolution sets in once again.

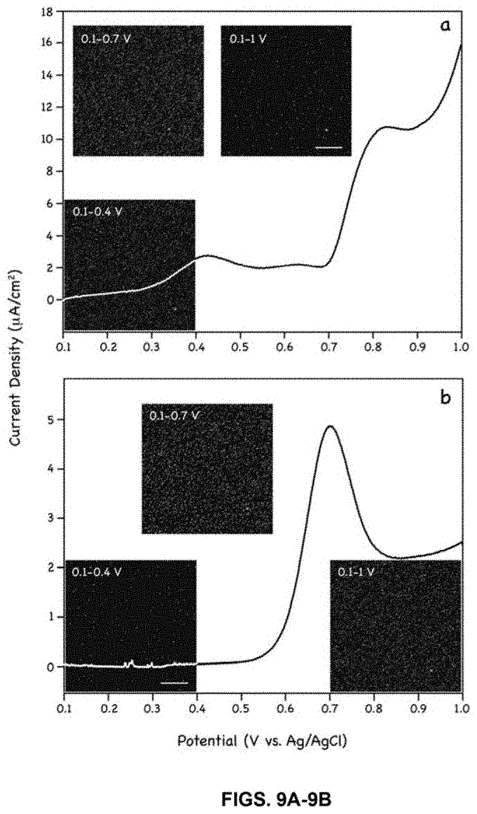

Fluorescence Microscopy Confirmation of Colloidal Deposition. With the background processes established, we next examined the deposition behavior of 0.5-μm-diameter PS-COOH beads using bare Au films as the working electrode. As evident from FIG. 9a, a submonolayer deposition of randomly distributed beads occurred readily when the electrode was biased by a linear potential sweep from 0.1 to 0.4 V vs. Ag/AgCl. The main redox feature within this potential window roughly coincides with that observed from bare Au probed in water alone (FIG. 8b), but with an intensified current output. A similar deposition results when the bias is extended to 0.7 V, within which a small but discernable wave appears at about 0.6 V. Immediately following this wave, the current rises significantly, which, after a brief plateau, is substituted by the oxygen evolution reaction at about 0.9 V. Because this feature is absent from the background responses and prior to it microbead deposition has already occurred, we tentatively assign it as expedited Au oxide formation facilitated by the PS-COOH microbeads on-electrode. Since the oxygen evolution causes the Au film to dissolve, the majority of the deposited microbeads are removed from the surface at the end of the 0.1-1 V scan.

Similar tests were then run on Au films covered with 1:1 Fc-C11SH/C12SH mixed SAMs. The SAM modification of the working electrode completely alters the redox processes in operation and hence the course of colloid deposition. Starting off, the relatively quiet electrochemical process within 0.1-0.4 V only led to low-level colloid deposition, whereas submonolayer colloid depositions with coverage comparable to that seen on bare gold were obtained in the next two potential windows (FIG. 9b). The stable deposition obtained from 0.1-1 V scan apparently benefited from the shielding/protection of Au films by the SAM. In the entire scan, there exists only one main electrochemical wave, which starts to rise past 0.5 V and subsequently peaks at 0.7 V. This feature results from the superimposition of at least two redox processes: Au oxide formation (FIG. 8b) and Fc SAM oxidation. The latter process, as will be elaborated in more detail later, is compensated mostly by chloride ions leaked into the solution from the Ag/AgCl reference electrode.

While the fluorescence images in FIG. 9 (as well as elsewhere in the main text) are taken using a 10× objective lens focused near the center of Au electrodes, low-magnification (4×) imaging was also performed on above samples to cover larger areas of colloidal deposits. These images display radially distributed microbead patterns, clearly due to the ring-shaped Pt wire C.E. that causes distortion of the electric field. The patterns formed on bare electrodes are very distinguishable from those on SAM-covered electrodes; the uniform coverage achieved on the latter after 0.1-1 V LSV scan is also evident.

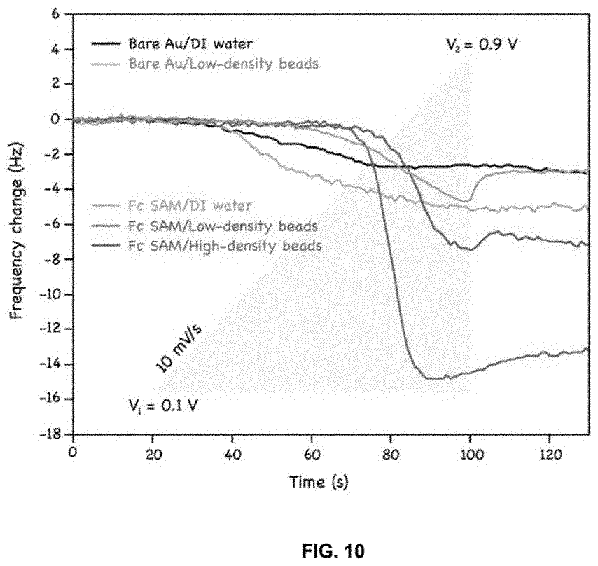

Electrochemical QCM Characterization of Deposition. To further characterize these colloid deposition processes, we also carried out electrochemical microbalance (QCM) analysis. By employing Au films directly coated on quartz crystal disks as the working electrode, this technique reveals the mass change on the electrode in real time as the associated electrochemical process takes place.^{[23]} For the bare Au electrode probed in water alone (FIG. 10, black trace), the crystal oscillation frequency tips downward shortly after the inauguration of the LSV scan, indicating a mass gain on the electrode that is likely due to the oxide formation on the gold film. The frequency decrease continues at a slow pace before reaching a plateau after 0.7 V vs. Ag/AgCl. When the system is in addition suspended with 0.5-μm PS-COOH beads, the same LSV scan produces a frequency profile with greater downward shift, which can be assigned to the accompanying colloid deposition on the electrode (FIG. 10, gray trace). The concurrency of frequency change shown by the two profiles, moreover, indicates a likely connection between Au oxide formation and bead deposition. To be consistent with the conventional nomenclature and distinguish it from the Fc-SAM based process, however, we describe colloidal assemblies formed on bare Au as electrical deposition throughout this work.

Similar tests once again were carried out on Au films covered with 1:1 Fc-C11SH/C12SH mixed SAMs. Here, several deviations are apparent. 1) Onset potential for frequency downshift. Due to suppression of gold oxidation by the SAM, the crystal oscillation frequencies do not shift downward appreciably until 0.4 V (in water alone) or past 0.5 V (in colloid aqueous suspensions), matching well with the LSV results (FIGS. 8b and 9b); 2) Correspondence between the colloid deposition and Fc oxidation. The steepest frequency decreases coincide with the voltammetric peak of Fc oxidation, which strongly suggests the latter process is responsible for the observed deposition; 3) Magnitude/speed of frequency shifts. For the same concentration of suspended PS-COOH microbeads, the frequency shift takes place more steeply on SAM-covered electrode than on the bare electrode. A >60% higher downshift was also observed on SAM-covered electrode (FIG. 10, red vs. gray traces) at the end of the LSV scan; 4) Dependence of deposition on colloid concentration. When the bead density was increased from 1×10⁷ to 1×10⁹ per mL, an approximate doubling of frequency downshift was registered. In the latter case, a frequency minimum was reached before the end of the scan (˜0.8 V), suggesting faster bead deposition and saturation on the SAM. A similar trend was also shown by the accompanying resistance change profiles: greater resistance upshifts on Fc-SAMs and in the presence of a higher concentration of beads.

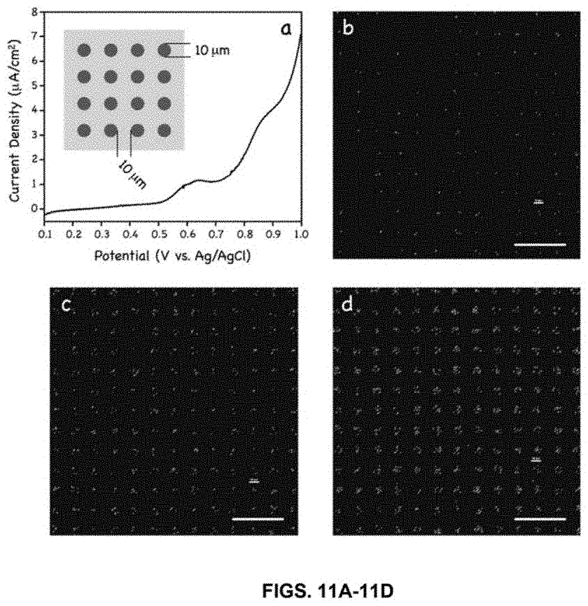

Simultaneous Electrochemical and Electrical Deposition. With the results presented above establishing colloidal deposition on both SAM-covered electrodes and bare electrodes, an interesting question emerges: Are they the same or different processes? To answer this question, Au films partially covered with SAMs was employed so that the two formats of deposition can be run side-by-side on the same electrode. To achieve such partial coverage, we chose to graft the thiols onto the bare Au electrodes via a pre-patterned silicone rubber stamp, using the microcontact printing (μCP)^{[24]} technique initially developed by the Whitesides group. As shown schematically in FIG. 11a, the stamp carries positive features of a 10-μm-diameter micropillar array with 10-μm spacing, which, upon printing, will yield SAM patterns with the same shape/dimension on the electrodes.

As before, LSV scans were run on these thiol-patterned Au film electrodes in three potential windows in 0.5-μm-diameter PS-COOH bead aqueous suspensions. Upon the initial 0.1-0.4 V sweep, strikingly, a microbead array that reproduces the original pattern on the stamp results (FIG. 11b). Despite their low coverage, the fact that the beads only land on spots where the thiols are put down via μCP is unmistakable. Such exclusive deposition becomes more evident as a result of more extended potential scans (FIG. 11c, d), yielding on average 3-5 beads per SAM micropatch after the 0.1-0.7 V run and 7-10 beads after the 0.1-1 V run. Since deposition occurs more efficiently on bare Au alone than on SAM-covered electrodes in the potential window of 0.1-0.4 V (FIG. 9), it follows that the thiol anchorage on gold completely disables the remaining open Au surface from recruiting microbeads.

Effect of Supporting Electrolyte. To better understand the electrohydrodynamic characteristics of these colloidal particles during Fc SAM oxidation, a series of parameters critically involved in the deposition process was examined. This started with small supporting electrolyte, in which we examined how the presence of either NaClO₄ or NaCl in the system would influence the deposition. Of the two, perchlorate stands clearly as the electrolyte of choice for probing Fc SAM electrochemistry, owing to its low hydration that leads to strong ion-pairing with ferrocenium.^{[25,26]} In comparison, the highly solvated chloride ions^{[26]} are less effective in accommodating the Fc/Fc⁺ transition, giving rise to a higher Fc oxidation potential.

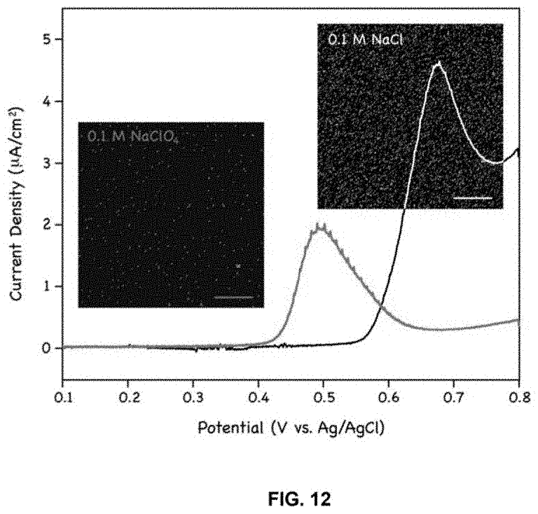

When the SAM-modified Au film electrodes were probed in 0.1 M NaClO₄ (together with 0.5-μm-diameter PS-COOH beads), a typical bell-shaped Fc SAM oxidation voltammogram was obtained^{[27]} (FIG. 12). Remarkably, a >80% decrease in the bead coverage was detected on the electrode compared to that obtained in DI water after the 0.1-0.7 V scan (FIG. 9b), which indicates NaClO₄ can effectively suppress colloid deposition. In contrast, colloidal deposition proceeds largely undisturbed in the presence of 0.1 M NaCl (FIG. 12), which remains the case even when the NaCl concentration is raised to 2 M. Taken together, these results strongly suggest the direct involvement of ferrocenium in driving colloidal deposition, whose neutralization by perchlorate (but not chloride) effectively abolishes the deposition process.

On the other hand, the voltammogram obtained in 0.1 M NaCl matches the one shown in FIG. 9b closely in shape and peak position, confirming that chloride ions are also responsible for charge compensation in the earlier case.

Effect of Colloid Size. To further shed light on the deposition mechanisms, we also extended the above characterization procedure to 5 other PS-COOH bead samples, which together cover two orders of colloid size. The fluorescence imaging results of the deposited PS-COOH beads are shown in FIG. 13. Among these, the 60-nm beads are not individually resolved due to their small size, resulting in a relatively weak, continuous fluorescent image. As will become evident later, their deposition has successfully occurred nevertheless. In general, as the size of colloids increases, their distribution becomes less even. This trend is most evident for the 2-μm and 5-μm samples, in which cases most deposited particles actually exist in clusters. The coverage of these two microbeads on electrodes is also noticeably lower than other samples. Factors that may cause such characteristic formations will be discussed in a later section.

Effect of Scan Rate. Finally, the effect of LSV scan rate on the colloid deposition was examined. As summarized in Table 4, comparable deposition was obtained at relatively slow scan rates, i.e., between 10 mV/s and 100 mV/s, for 0.5-μm PS-COOH beads; as the scan rate increases further, a steady decrease of colloid surface coverage results. At the highest scan rate tested, 1 V/s, for example, the count of deposited particles drops by >80% compared to that obtained at 10 mV/s and 100 mV/s. Using the latter rate as the threshold at which the colloid mass transfer limit (by diffusion) sets in, we can roughly estimate a timescale of a few seconds, i.e., the minimum time needed for a full-extent deposition of 0.5-μm PS-COOH beads on 1:1 Fc-C11SH/C12SH mixed SAMs.

TABLE 4
Scan rate dependence of electrochemically triggered
deposition of 0.5-μm-diameter PS-COOH beads.

| Scan rate | Particle | |
|---|---|---|
| (mV/s)^{a} | coverage (%) | Particle count |
| 10 | 8.9 ± 0.7^{b} | 3127 ± 138^{b} |
| 100 | 9.4 ± 0.3^{b} | 2955 ± 114^{b} |
| 250 | 6.8 ± 0.5^{b} | 1896 ± 97^{b} |
| 500 | 3.7 ± 0.2^{b} | 847 ± 48^{b} |
| 1000 | 2.2 ± 0.5^{b} | 559 ± 147^{b} |

^{a}Results obtained from a single LSV scan from 0.1 to 0.8 V at 10 mV/s; bead concentration: 9.58 × 10⁹ per mL; ^{b}Standard deviation, n = 3 or 4.

Deposition Mechanisms. With all the characterization results presented above, a preliminary and qualitative analysis of the involved deposition mechanisms in this section was attempted.

1) Magnitude and distribution of the electric field. In order to assess the relative contribution of each possible mode of motion, it is helpful to first establish the size/distribution of electric field (E) present in the system. For that, the potential drop on both working and counter electrodes was determined. For the latter, we take the value of −0.6 V vs. Ag/AgCl, assuming 2H⁺+2e⁻=H₂ under neutral pH as the redox process occurring on the Pt wire.^{[28]} Taking the peak potentials on working electrodes to be 0.4 V (bare Au, FIG. 9) and 0.7 V (SAM-covered Au, FIG. 9), respectively, and the distance between W.E. and C.E. to be 0.3 cm (FIG. 8), their corresponding apparent electric field: 3.3 and 4.3 V/cm were estimated. It is important to note once again that the electric field is not uniform in either case.

As discussed above, significant concentrations of KCl were expected to be present in the colloidal suspensions due to its leakage from the reference electrode. This condition gives rises to a thin double-layer surrounding the PS-COOH beads, i.e., with their Debye length expected to be on the order of nm.^{[29]} By contrast, the double-layer structure associated with the electrode prior to the potential sweep is less well-defined due mainly to the hydrophobicity of the SAM surface.

2) Classical/Linear electrophoretic motion of colloidal particles. As the linear potential sweep is switched on, an electric field starts to develop between the W.E. and C.E., to which the negatively charged colloidal particles have to respond with electrophoretic motion. The resultant electrophoretic mobility (μ) can be estimated from the zeta potential of the colloid according to the Helmholtz-Smoluchowski equation:^{[30}] μ=ε₀ϵζ/η, in which ζ is the zeta potential of the particle, ε₀ the vacuum permittivity, ε and η are respectively the relative dielectric permittivity and viscosity of the medium. From the zeta potential measured for the 0.5-μm PS-COOH beads, −35.6 mV (Table 3), we then obtain μ at −2.5×10⁻⁴ cm²V⁻¹s⁻¹, which, under the pertinent electric field, corresponds to a scenario where a microbead migrates at most 10 μm a second. On the other hand, if the bead movement is driven by such electrophoresis alone, longer runs should always result in more extensive deposition. The fact that this is not the case, e.g., in 10 mV/s vs. 100 mV/s depositions, therefore, points to the likely presence of other driving mechanism(s) in the current system.

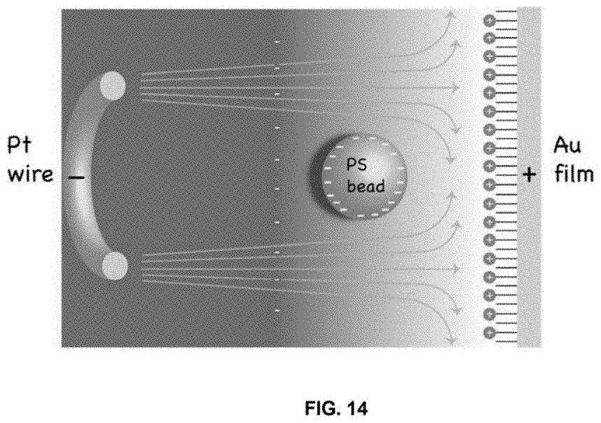

3) Faradaic-charge-induced electrophoresis and electroosmosis. Upon Fc oxidation, a positively-charged layer starts to emerge at the SAM/water interface. This instantaneously triggers an influx of anions toward the SAM-covered electrode, which in turn creates a region near the surface where surface cations (i.e., ferrocenium) and the incoming anions are separated in space. As the oxidative current continues to develop, this zone of charge imbalance expands further into the bulk, producing a double-layer that is considerably thicker than normal. The physical significance of this dipolar zone lies in that 1) it imposes a second electric field on top of the external electric field and 2) the electrostatic interactions between the two fields create a whole new series of electrokinetic flows in the system. To begin with, a secondary electrophoretic motion arises because this bulk charge region directly modifies the charge distribution on the surface of colloidal particles dispersed within (FIG. 14). Similarly, any tangential field component existing in the system can cause the incoming counter anions to slip at the SAM surface, i.e., electroosmotic flow (EOF), which in turn triggers circulating fluid movement capable of carrying the suspended colloids toward the electrode surface (FIG. 14).

According to the existing theoretical models on induced-charge electroosmosis^{[15,16]} as well as the ‘electrokinetic phenomena of the second kind’,^{[31,32]} the velocity (u) of such induced electrokinetic flows generally takes the nonlinear Smoluchowski form, u 0∝ε₀εEEᵢa/η, where E and Eᵢ are the primary and induced electric field components, respectively, and a the particle radius. In comparison to the linear Smoluchowski formula,^{[30]} here Eᵢ appears in place of ζ, whereas the new term, a, marks the size-dependent nature of such flows. Of the former, it is precisely because Eᵢ can be substantially larger than ζ that these secondary electrokinetic flows sometimes exceed the classical motions in velocity by several orders of magnitude.^{[31,32]} On the other hand, it is tempting to attribute the observed clustering of large microbeads (2-μm and 5-μm, FIG. 13) to the size dependence predicted of these nonlinear induced electrokinetic flows. Their low surface coverage, on the other hand, is likely due to a combination of the following two factors: their lower starting concentrations (Table 3) and slower diffusion. The latter process scales with 1/a and is expected to pose a more severe mass-transfer limit on these larger beads once they are depleted near the electrode by the secondary electrokinetic flows. This attribution is also in line with the different impacts on the colloidal deposition observed between ClO₄⁻ and Cl⁻ (FIG. 12): due to its strong ion-pairing with Fc⁺, ClO₄⁻ does not effectively sustain EOF. Without EOF carrying the microbeads toward the electrode, accordingly, the resulting deposition is greatly suppressed.

Extrapolating from the observations above, we can see easily the likely importance of many other factors associated with the Faradaic processes, such as type/kinetics of the involved electrochemical reaction(s), in the colloidal deposition. For instance, although gold oxidation itself is sufficient to trigger deposition on bare Au electrodes (FIG. 9a), it is sluggish and does not produce nearly as much charge as the competing reaction, Fc-e⁻=Fc⁺. These enable the latter reaction to sustain secondary electrokinetic flows much more strongly, which in turn lead to faster colloid deposition (FIG. 10) and a complete dominance over the gold-oxidation based process (FIG. 11).

4) The actual deposition and post-deposition stability. Another conclusion from the discussion so far is that Faradaic reactions can accelerate the arrival of colloidal particles at the electrode. Mechanically, this fast motion may lead to a ‘hard landing’ scenario, in which the momentum due to colloid stoppage at the surface may afford the particle a closer contact with the SAM and hence more intimate electrostatic and van der Waal interactions than otherwise possible. Of course, with the colloid's fixed surface charge releasing small ions and water into the bulk, the deposition process also leads to an entropy gain of the system. These considerations help explain the observation of irreversible surface adhesion of microbeads following electrochemically triggered deposition. For example, the deposited beads can withstand typical washing steps well and do not come off the electrode until we electrochemically desorb the SAM underneath at ˜2.0 V vs. Ag/AgCl. By contrast, colloidal formations driven by electrophoretic deposition are often reversible assemblies.^{[7]} Once the electric field is switched off, a random distribution of the colloidal particles often resumes as a result of Brownian motion; alternatively, the initially deposited colloids can be lifted off from the electrode by reversing the field polarity.

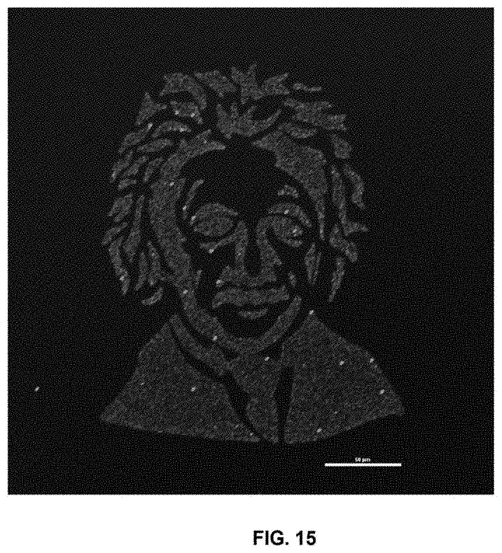

Electrochemically Triggered Colloid Micropattern Formation on Electrodes. An Application. Taking advantage of the superior efficiency of the electrochemically triggered assembly compared to the electrically driven process, this investigation was concluded with a demonstration of fast, high-fidelity colloid micropattern formation on electrodes. Shown in FIG. 15 is a ˜200×300-μm portrait of Einstein formed by 60-nm fluorescent PS-COOH beads electrochemically assembled on a Au film electrode. Fine lines down to just a few microns are satisfactorily resolved. A cartoon rendering of the historical ‘Moon Landing’ with similar resolution is also included as the TOC graphic of this work. Separately, we also attempted similar patterning/assembly using C12SH alone as the ink followed by electrical deposition, which fails to produce any recognizable microbead patterns on the electrode. This negative control once again illustrates the critical role played by Fc in achieving successful micropattern formation. Using better-resolved stamps and colloids of smaller size, it should be possible construct still finer features in a similar fashion.

Summary

A new electrochemical method for efficient and straightforward deposition/assembly of aqueous-suspended colloids on electrode surfaces has been presented. Using carboxylic-terminated polystyrene nano-/microbeads as a model colloid, the electrochemically triggered process provides superior deposition efficiency. A qualitative discussion of the involved deposition mechanisms is also given, featuring secondary, induced electrokinetic flows carrying the microbeads toward the electrode surface. To showcase the potential utility of this method, fast and high-fidelity colloid micropattern formation on electrodes was demonstrated.

The approach described here offers several exciting new possibilities. Fundamentally, adding well-defined faradaic reactions into the deposition process offers a new and largely independent mechanism to induce secondary electric field components. With their great design flexibility, SAMs brings a new dimension into controlling/tuning various physicochemical parameters involved the deposition process. Through control of Fc density in the SAMs, for instance, one can easily access a range of surface potentials following the same preparation procedure. Since all redox-active materials are surface-bound, importantly, such gains in control and efficiency are achieved without complicating/compromising the solution phase. On the other hand, the low-voltage and fast operation characteristic of this approach should make it an appealing alternative for applications involving colloidal assemblies.^{[7-9]} Auxiliary techniques amenable to the SAM formation, such as microcontact printing employed herein, will certainly extend the level of control and sophistication of these practices further.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

### REFERENCES

1. N. L. Abbott, G. M. Whitesides, Langmuir 1994, 10, 1493-1497.
2. G. R. Whittell, I. Manners, Adv. Mater. 2007, 19, 3439-3468.
3. M. Gallei, C. Rüttiger, Chem. Eur. J. 2018, 24, 10006-10021.
4. M. Giersig, P. Mulvaney, Langmuir 1993, 9, 3408-3413.
5. M. Trau, D. A. Saville, I. A. Aksay, Science 1996, 272, 706-709.
6. S.-R. Yeh, M. Seul, B. I. Shraiman, Nature 1997, 386, 57-59.
7. D. C. Prieve, J. P. Sides, C. L. Wirth, Curr. Opin. Colloid Interface Sci. 2010, 15, 160-174.
8. Z. Lu, Y. Yin, Chem. Soc. Rev. 2012, 41, 6874-6887.
9. M. A. Boles, M. Engel, D. V. Talapin, Chem. Rev. 2016, 116, 11220-11289.
10. R. W. O'Brien, L. R. White, 1978, 74, 1607-1626.
11. J. L. Anderson, Ann. Rev. Fluid Mech. 1989, 21, 61-99.
12. Y. Solomentsev, M. Böhmer, J. L. Anderson, Langmuir 1997, 13, 6358-6368.
13. M. Böhmer, Langmuir 1996, 12, 5747-5750.
14. Trau, M.; Saville, D. A.; Aksay, I. A. Langmuir 1997, 13, 6375-6381.
15. T. M. Squires, M. Z. Bazant, J. Fluid Mech. 2004, 509, 217-252.
16. M. Z. Bazant, T. M. Squires, Curr. Opin. Colloid Interface Sci. 2010, 15, 203-213
17. R. J. Kershner, J. W. Bullard, M. J. Cima, J. Colloid Interface Sci. 2004, 278, 146-154.
18. W. D. Ristenpart, I. A. Aksay, D. A. Saville, Langmuir 2007, 23, 4071-4080.
19. J. F. L. Duval, G. K. Huijs, W. F. Threels, J. Lyklema, H. P. van Leeuwen, J. Colloid Interface Sci. 2003, 260, 95-106.
20. M. S. Iqbal, W. Zhan, Langmuir 2018, 34, 12776-12786.
21. M. M. Jaksic, B. Johansen, R. Tunold, Int. J. Hydrogen Energy 1993, 18, 91-110.
22. S. J. Xie, V. I. Birss, J. Electroanal. Chem. 2001, 500, 562-573.
23. D. A. Buttry, M. D. Ward, Chem. Rev. 1992, 92, 1355-1379.
24. A. Kumar, H. A. Biebuyck, G. M. Whitesides, Langmuir 1994, 10, 1498-1511.
25. G. K. Rowe, S. E. Creager, J. Phys. Chem. 1994, 98, 5500-5507.
26. G. Valincius, G. Niaura, B. Kazakevičiene, Z. Talaikytė, M. Kažemėkaitė, E. Butkus, V. Razumas, Langmuir 2004, 20, 6631-6638.
27. The peak potential, ˜0.5 V vs. Ag/AgCl, is noticeably more positive than the values typically reported in literature, e.g., 0.32 V in our earlier report (ref. 20), which we find is mostly caused by the different electrode configuration employed in this work.
28. M. J. N. Pourbaix, J. Van Muylder, N. de Zoubov, Platinum Metals Rev. 1959, 3, 47-53.
29. Israelachvili, J. N. Intermolecular and Surface Forces, 3rd ed.; Elsevier Inc.: Amsterdam, The Netherlands, 2011.
30. Hunter, R. J. Zeta Potential in Colloid Science, Academic Press Inc.: London, U K, 1981.
31. S. S. Dukhin, Adv. Colloid Interface Sci. 1991, 35, 173-196.
32. A. A. Baran, N. A. Mishchuk, D. C. Prieve, J. Colloid Interface Sci. 1998, 207, 240-250.

We claim:

1. A method for immobilizing a polyionic species from a solution, the method comprising contacting the solution with a substrate comprising a plurality of oxidized organometallic species on a surface of the substrate, wherein the metal comprises iron, ruthenium, osmium, cobalt, or any combination thereof.

2. The method of claim 1, wherein the plurality of organometallic species is covalently bonded to the surface of the substrate by an organic linker.

3. The method of claim 2, wherein the organic linker comprises a substituted or unsubstituted alkylene group.

4. The method of claim 2, wherein the organic linker comprises a ligand that binds with the metal ion.

5. The method of claim 4, wherein the ligand comprises a corrole, a crown ether, a cryptate, cyclopentadiene, diethylenetriamine (dien), dimethylglyoximate (dmgH⁻), 1,4,7,10-tetraazacyclododecane-1,4,7,10-tetraacetic acid (DOTA), diethylenetriaminepentaacetic acid (DTPA) (pentetic acid), ethylenediaminetetraacetic acid (EDTA) (edta⁴⁻), ethylenediaminetriacetate, or ethyleneglycolbis(oxyethylenenitrilo)tetraacetate (egta⁴⁻).

6. The method of claim 1, wherein the organometallic species are pendant groups on a polymer backbone.

7. The method of claim 1, wherein the substrate comprises gold, glass, aluminum, copper and carbon.

8. The method of claim 1, wherein the substrate comprises a semiconductor material comprising TiO₂, V₂O₅, ZnO, SnO₂, Fe₂O₃, In₂O₃, ZrO₂, WO₃, MoO₃, SiC, ZS, CdS, MoS₂, an ilmenite, FeTiO₃, FeCrO₄, a perovskite, or a pseudobrookite.

9. The method of claim 1, wherein a plurality of precursor organometallic species is oxidized to produce the plurality of metal ions on the surface of the substrate.

10. The method of claim 9, wherein the plurality of precursor organometallic species is oxidized by chemical oxidation.

11. The method of claim 9, wherein the plurality of precursor organometallic species is oxidized by applying a potential to the substrate comprising the plurality of precursor organometallic species.

12. The method of claim 11, wherein the potential bias is provided from about +1-0.1 V to about 1 V.

13. The method of claim 11, wherein the potential is applied by one or more electrodes.

14. The method of claim 1, wherein (1) the substrate is contacted with the solution comprising the polyionic species followed by (2) applying a potential to the substrate.

15. The method of claim 1, wherein (1) a potential is applied to the substrate followed by (2) contacting the substrate with the solution comprising the polyionic species.

16. The method of claim 1, wherein the substrate comprises a plurality of ferrocene groups, wherein the plurality of ferrocene groups is oxidized by applying a potential to the substrate to produce a plurality of ferrocenium ions on the surface of the substrate.

17. The method of claim 1, wherein the polyionic species comprises a neutral compound, a salt thereof, or a combination thereof.

18. The method of claim 1, wherein the polyionic species comprises a polyanion, wherein the polyanion comprises a polymer comprising two or more carboxylate groups, sulfate groups, sulfonate groups, borate groups, boronate groups, phosphonate groups, or phosphate groups.

19. The method of claim 1, wherein the polyionic species comprises a polycation, wherein the polycation comprises a polymer comprising two or more amine groups.

20. The method of claim 1, wherein the polyionic species comprises a quantum dot, a liposome, a metal nanoparticle, a magnetic nanoparticle, a carbon nanotube, an antibody, a colloid, an oligonucleotide, a polypeptide, or a protein.

21. The method of claim 1, wherein the solution comprises water.

22. A substrate comprising an immobilized a polyionic species produced by the method of claim 1.

23. A sensor comprising the substrate of claim 22.
